(19) United States
(12) Patent Application Publication
(10) Pub. No.: US 2014/0087251 A1
(43) Pub. Date: Mar. 27, 2014

(54) ELECTRODE MATERIAL FOR POWER STORAGE DEVICE, ELECTRODE FOR POWER STORAGE DEVICE, AND POWER STORAGE DEVICE

(71) Applicant: SEMICONDUCTOR ENERGY LABORATORY CO., LTD., Atsugi-shi (JP)

(72) Inventors: Minoru TAKAHASHI, Matsumoto (JP); Ryota Tajima, Isehara (JP); Kazutaka Kuriki, Ebina (JP)

(73) Assignee: SEMICONDUCTOR ENERGY LABORATORY CO., LTD., Atsugi-shi (JP)

(21) Appl. No.: 14/029,853

(22) Filed: Sep. 18, 2013

(30) Foreign Application Priority Data
Sep. 21, 2012 (JP) 2012-208126

(51) Int. Cl. H01M 4/62

(52) U.S. Cl. CPC H01M 4/628
USPC 429/211; 429/209; 429/231.8; 429/218.1

(57) ABSTRACT

Irreversible capacity which causes a decrease in the initial capacity of a power storage device is reduced and the electrochemical decomposition of an electrolytic solution is suppressed. The decomposition reaction of an electrolytic solution as a side reaction of a power storage device is reduced or suppressed to improve the cycle performance of the power storage device. An electrode material for a power storage device includes active material particles and coating films covering part of surfaces of the active material particles. Carrier ions used for the power storage device can pass through the coating film. The product of the electric resistivity and the thickness of the coating film at 25° C. is greater than or equal to 20 Ωm·m.

### BACKGROUND OF THE INVENTION

1. Field of the Invention

The present invention relates to an electrode material for a power storage device, an electrode for a power storage device, and a power storage device.

2. Description of the Related Art

In recent years, secondary batteries such as lithium-ion secondary batteries, lithium-ion capacitors, and air cells have been actively developed. In particular, demand for lithium-ion secondary batteries with high output and high energy density has rapidly grown with the development of the semiconductor industry, for electronic devices, for example, portable information terminals such as cell phones, smartphones, and laptop computers, portable music players, and digital cameras; medical equipment; next-generation clean energy vehicles such as hybrid electric vehicles (HEVs), electric vehicles (EVs), and plug-in hybrid electric vehicles (PHEVs); and the like. The lithium-ion secondary batteries are essential as chargeable energy supply sources for today's information society.

A negative electrode for power storage devices such as lithium-ion secondary batteries and the lithium-ion capacitors is a structure body including at least a current collector (hereinafter referred to as a negative electrode current collector) and an active material layer (hereinafter referred to as a negative electrode active material layer) provided over a surface of the negative electrode current collector. The negative electrode active material layer contains an active material (hereinafter referred to as a negative electrode active material) which can receive and release lithium ions serving as carrier ions, such as a carbon material or an alloy.

At present, a negative electrode of a lithium-ion secondary battery which contains a graphite-based carbon material is generally formed by mixing graphite as a negative electrode active material, acetylene black (AB) as a conductive additive, PVDF, which is a resin as a binder, to form slurry, applying the slurry over a current collector, and drying the slurry, for example.

Such a negative electrode for a lithium-ion secondary battery and a lithium-ion capacitor has an extremely low electrode potential and a high reducing ability. For this reason, an electrolytic solution containing an organic solvent is subjected to reductive decomposition. The range of potentials in which the electrolysis of an electrolytic solution does not occur is referred to as a potential window. A negative electrode essentially needs to have an electrode potential in the potential window of an electrolytic solution. However, the negative electrode potentials of a lithium-ion secondary battery and a lithium-ion capacitor are out of the potential windows of almost all electrolytic solutions. Actually, a decomposition product of an electrolytic solution forms a surface film (also referred to as solid electrolyte interphase) on the surface of a negative electrode, and the surface film suppresses further reductive decomposition. Consequently, lithium ions can be inserted into the negative electrode with the use of a low electrode potential below the potential window of an electrolytic solution (for example, see Non-Patent Document 1).

However, such a surface film on a negative electrode which is formed by a decomposition product of an electrolytic solution suppresses the decomposition of the electrolytic solution, which leads to a gradual deterioration. Therefore, such a surface film is not a stable film. In particular, a high temperature increases the decomposition reaction rate; thus, the decomposition reaction greatly hinders operation of a battery in high temperature environments. In addition, the formation of the surface film causes irreversible capacity, so that part of charge and discharge capacity is lost. For these reasons, there is demand for an artificial coating film which is different from the surface film, that is, an artificial coating film on the surface of the negative electrode which is more stable and can be formed without losing capacity.

Further, such a surface film does not have electric conductivity and thus the electric conductivity of an electrode covered with a surface film is low while a battery is charged and discharged, so that electrode potential distribution is inhomogeneous. Accordingly, the charge and discharge capacity of a power storage device is low, and the cycle life of the power storage device is short due to local charge and discharge.

At present, as an active material in a positive electrode of a lithium-ion secondary battery, for example, a lithium-containing composite oxide is used. The decomposition reaction between such a material and an electrolytic solution occurs at high temperature and at high voltage, and accordingly, a surface film is formed due to the decomposition product. Therefore, irreversible capacity is caused, resulting in a decrease in charging and discharging capacity.

### REFERENCE

[Non-Patent Document 1] Zempachi Ogumi, “Lithium Secondary Battery”, Ohmsha, Ltd., the first impression of the first edition published on Mar. 20, 2008, pp. 116-118

### SUMMARY OF THE INVENTION

Conventionally, a surface film on the surface of an electrode is considered as being formed due to a battery reaction in charging, and charge used for forming the surface film cannot be discharged. For this reason, irreversible capacity resulting from the electric charge used for forming the surface film reduces the initial capacity of a lithium-ion secondary battery.

Further, it has been believed that even a surface film formed on an electrode in the initial charge is not sufficiently stable and does not completely prevent the decomposition of an electrolytic solution, and the decomposition of the electrolytic solution proceeds particularly at high temperature.

As the electrochemical decomposition of an electrolytic solution proceeds, the amount of lithium responsible for charge and discharge is decreased in accordance with the number of electrons used in the decomposition reaction of the electrolytic solution. Therefore, as charge and discharge are repeated, the capacity of a lithium-ion secondary battery is lost after a while. In addition, the higher the temperature is, the faster the electrochemical reaction proceeds. Thus, the capacity of a lithium-ion secondary battery decreases more significantly as charge and discharge are repeated at high temperature.

Not only lithium-ion secondary batteries but also power storage devices such as lithium-ion capacitors have the above problems.

In view of the above, an object of one embodiment of the present invention is to reduce irreversible capacity which causes a decrease in the initial capacity of a power storage device and to reduce or suppress the electrochemical decomposition of an electrolytic solution.

Another object of one embodiment of the present invention is to reduce or suppress the decomposition reaction of an electrolytic solution as a side reaction of charge and discharge in the charge and discharge cycles of a power storage device in order to improve the cycle performance of the power storage device.

Another object of one embodiment of the present invention is to reduce or suppress the decomposition reaction of an electrolytic solution, which is accelerated at high temperature, and to prevent a decrease in capacity in charge and discharge at high temperature, in order to extend the operating temperature range of a power storage device.

One embodiment of the present invention provides an electrode material for a power storage device which achieves the above object.

One embodiment of the present invention provides an electrode for a power storage device which achieves the above object.

One embodiment of the present invention provides a power storage device including the electrode for a power storage device.

In view of the above objects, the present inventors formed a coating film containing an insulating metal oxide and the like on the surface of an active material in advance and used it as an electrode material for a power storage device. The use of the coating film was able to reduce or suppress the decomposition of an electrolytic solution around the surface of the active material which occupied a large area of the electrode. Thus, when the coating film was formed on the surface of an active material, the thickness of a surface film was thinner than that in the case of not forming the coating film, or a surface film was not formed.

Here, the present inventors paid attention to the thickness of a surface film which depends on the thickness of a coating film and examined the correlation between the thickness of the coating film and the thickness of a surface film with the use of a variety of materials. Then, the present inventors found that the thickness of a surface film depends on the electric resistivity of the coating film regardless of a material of the coating film.

That is to say, one embodiment of the present invention is an electrode material for a power storage device. The electrode material includes active material particles with coating films covering part of surfaces of the active material particles. Carrier ions used for the power storage device can pass through the coating film. The product of the electric resistivity and the thickness of the coating film at 25° C. is greater than or equal to 20 Ωm·m.

A material which enables charge-discharge reaction by insertion and extraction of carrier ions is used as an active material for an electrode material for a power storage device of one embodiment of the present invention, and in particular, such a material having a particle shape is used.

Here, “particle” is used to indicate the exterior shape of an active material having a given surface area, such as a spherical shape (powder shape), a plate shape, a horn shape, a columnar shape, a needle shape, or a flake shape. The active material particles are not necessarily in spherical shapes and the particles may have given shapes different from each other. A method for forming active material particles is not limited as long as the active material particles have any of the above shapes.

There is no particular limitation on the average diameter of the active material particles; active material particles with general average diameter or diameter distribution are used. In the case where the active material particles are negative electrode active material particles used for a negative electrode, negative electrode active material particles with an average diameter in the range from 1 μm to 50 μm, for example, can be used. In the case where the active material particles are positive electrode active material particles used for a positive electrode and each of the positive electrode active material particles is a secondary particle, the average diameter of primary particles composing the secondary particle can be in the range from 10 nm to 1 μm.

As a negative electrode active material, graphite, which is a carbon material generally used in the field of power storage, can be used. Examples of graphite include low crystalline carbon such as soft carbon and hard carbon and high crystalline carbon such as natural graphite, kish graphite, pyrolytic carbon, mesophase pitch based carbon fiber, mesocarbon microbeads (MCMB), mesophase pitches, petroleum-based and coal-based coke, and the like.

As the negative electrode active material, other than the above carbon materials, an alloy-based material which enables charge-discharge reaction by alloying and dealloying reaction with carrier ions can be used. In the case where carrier ions are lithium ions, for example, a material containing at least one of Mg, Ca, Al, Si, Ge, Sn, Pb, As, Sb, Bi, Ag, Au, Zn, Cd, Hg, In, etc. can be used as the alloy-based material. Such metals have higher capacity than carbon. In particular, silicon has a significantly high theoretical capacity of 4200 mAh/g. For this reason, silicon is preferably used as the negative electrode active material.

For a positive electrode active material, a material into and from which carrier ions can be inserted and extracted is used. For example, a compound such as LiFeO₂, LiCoO₂, LiNiO₂, LiMn₂O₄, V₂O₅, Cr₂O₅, and MnO₂ can be used.

Alternatively, a complex material (LiMPO₄ (general formula) (M is one or more of Fe(II), Mn(II), Co(II), and Ni(II))) can be used. Typical examples of the general formula LiMPO₄ which can be used as a material are lithium compounds such as LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≦1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≦1, 0<c<1, 0<d<1, and 0<e<1), and LiFe_{f}Ni_{q}CoₕMnᵢPO₄ (f+g+h+i≦1, 0<f<1, 0<g<1, 0<h<1, and 0<i<1).

Alternatively, a complex material such as Li₍₂₋ⱼ₎MSiO₄ (general formula) (M is one or more of Fe(II), Mn(II), Co(II), and Ni(II); 0≦j≦2) may be used. Typical examples of the general formula Li₍₂₋ⱼ₎MSiO₄ which can be used as a material are lithium compounds such as Li₍₂₋ⱼ₎FeSiO₄, Li₍₂₋ⱼ₎CoSiO₄, Li₍₂₋ⱼ₎MnSiO₄, Li₍₂₋ⱼ₎FeₖNiₗSiO₄, Li₍₂₋ⱼ₎FeₖCoₗSiO₄, Li₍₂₋ⱼ₎FeₖMnₗSiO₄, Li₍₂₋ⱼ₎NiₖCoₗSiO₄, Li₍₂₋ⱼ₎NiₖMnₗSiO₄ (k+l≦1, 0<k<1, and 0<l<1), Li₍₂₋ⱼ₎FeₘNiₙCo_{q}SiO₄, Li₍₂₋ⱼ₎FeₘNiₙMn_{q}SiO₄, Li₍₂₋ⱼ₎NiₘCoₙMm_{q}SiO₄ (m+n+q≦1, 0<m<1, 0<n<1, and 0<q<1), and Li₍₂₋ⱼ₎FeᵣNiₛCoₜMnᵤSiO₄ (r+s+t+u≦1, 0<r<1, 0<s<1, 0<t<1, and 0<u<1).

Examples of carrier ions used for a power storage device are lithium ions, which are a typical example thereof; alkali-metal ions other than lithium ions; alkaline-earth metal ions; beryllium ions; magnesium ions; and the like. In the case where ions other than lithium ions are used as carrier ions, the following may be used as the positive electrode active material: a compound which is obtained by substituting an alkali metal (e.g., sodium or potassium), an alkaline-earth metal (e.g., calcium, strontium, barium, beryllium, or magnesium) for lithium in any of the above lithium compounds and a composite of the obtained compounds.

Although descriptions are given above assuming that an active material has a particle shape, the shape of the active material is not limited to a particle shape; a similar effect can be obtained from active materials of one film-like shape and a stack of film-like shapes and a composite thereof as long as the active material is provided with the coating film of one embodiment of the present invention, whereby a similar effect can be obtained.

The coating film of one embodiment of the present invention is an artificial film provided in advance before a power storage device is charged and discharged, and is clearly distinguished from a surface film formed due to the decomposition reaction between an electrolytic solution and an active material in this specification and the like.

Carrier ions can pass through the coating film of one embodiment of the present invention. The coating film is formed using a material through which carrier ions can pass, and needs to be thin enough to allow carrier ions to pass through the coating film.

As a material of the coating film, an oxide film of any one of niobium, titanium, vanadium, tantalum, tungsten, zirconium, molybdenum, hafnium, chromium, aluminum, and silicon and an oxide film containing any one of these elements and lithium can be used. Alternatively, a polymer such as poly(ethylene oxide) (PEO) having permeability to carrier ions such as lithium ions may be used for the coating film. The coating film formed using such a material is denser than a conventional surface film formed on the surface of an active material due to a decomposition product of an electrolytic solution.

In the case of using an active material whose volume is changed in charging and discharging, the coating film is preferably changed following a change in shape due to the change in volume of the active material. Therefore, the Young's modulus of the coating film is preferably less than or equal to 70 GPa.

The product of the electric resistivity and the thickness of the coating film of one embodiment of the present invention at 25° C. is greater than or equal to 20 Ωm·m, preferably greater than or equal to 200 Ωm·m. The electric resistivity of a material depends on temperature. Therefore, in this specification and the like, the product of the electric resistivity and the thickness of the coating film in a measurement environment at 25° C., which is approximately room temperature, is indicated as a standard.

Note that in this specification and the like, a positive electrode and a negative electrode may be collectively referred to as an electrode; in this case, the electrode refers to at least one of the positive electrode and the negative electrode.

According to one embodiment of the present invention, irreversible capacity, which causes a decrease in the initial capacity of a power storage device, can be reduced and the electrochemical decomposition of an electrolytic solution and the like can be reduced or suppressed.

According to one embodiment of the present invention, the decomposition reaction of an electrolytic solution and the like caused as a side reaction of charge and discharge in the charge and discharge cycles of a power storage device can be reduced or suppressed, whereby the cycle performance of the power storage device can be improved.

According to one embodiment of the present invention, the decomposition reaction of an electrolytic solution, which is accelerated at high temperature, is reduced or suppressed to prevent a decrease in capacity in charge and discharge at high temperature, whereby the operating temperature range of a power storage device can be extended.

According to one embodiment of the present invention, an electrode material for a power storage device which achieves the above object can be provided.

According to one embodiment of the present invention, an electrode for a power storage device which achieves the above object can be provided.

According to one embodiment of the present invention, a power storage device including the electrode for a power storage device can be provided.

### BRIEF DESCRIPTION OF THE DRAWINGS

In the accompanying drawings:

FIGS. 1A and 1B each illustrate active material particles provided with coating films;

FIG. 2 shows a method for forming an electrode material for a power storage device;

FIGS. 3A to 3D illustrate a negative electrode;

FIGS. 4A to 4C illustrate a positive electrode;

FIGS. 5A and 5B each illustrate a power storage device;

FIGS. 6A and 6B illustrate power storage devices;

FIG. 7 illustrates electronic devices;

FIGS. 8A to 8C illustrate an electronic device;

FIGS. 9A and 9B illustrate an electronic appliance;

FIGS. 10A and 10B each illustrate a sample for measurement;

FIG. 11 shows the correlation between the thickness of a surface film and the thickness of a coating film; and

FIG. 12 shows the correlation between the thickness of a surface film and the product of the electric resistivity and the thickness of a coating film.

### DETAILED DESCRIPTION OF THE INVENTION

Hereinafter, embodiments and an example of the present invention will be described in detail with reference to the accompanying drawings. However, the present invention is not limited to the descriptions of the embodiments and example and it is easily understood by those skilled in the art that the mode and details can be changed variously. Therefore, the present invention should not be construed as being limited to the descriptions in the following embodiments and example.

Note that in drawings used in this specification, the thicknesses of films, layers, and substrates and the sizes of components (e.g., the sizes of regions) are exaggerated for simplicity in some cases. Therefore, the sizes of the components are not limited to the sizes in the drawings and relative sizes between the components.

Note that the ordinal numbers such as “first” and “second” in this specification and the like are used for convenience and do not denote the order of steps, the stacking order of layers, or the like. In addition, the ordinal numbers in this specification and the like do not denote particular names which specify the present invention.

Note that in structures of the present invention described in this specification and the like, the same portions or portions having similar functions are denoted by common reference numerals in different drawings, and descriptions thereof are not repeated. Further, the same hatching pattern is applied to portions having similar functions, and the portions are not especially denoted by reference numerals in some cases.

Note that in this specification and the like, a positive electrode and a negative electrode for a power storage device may be collectively referred to as an electrode; in this case, the electrode in this case refers to at least one of the positive electrode and the negative electrode.

### Embodiment 1

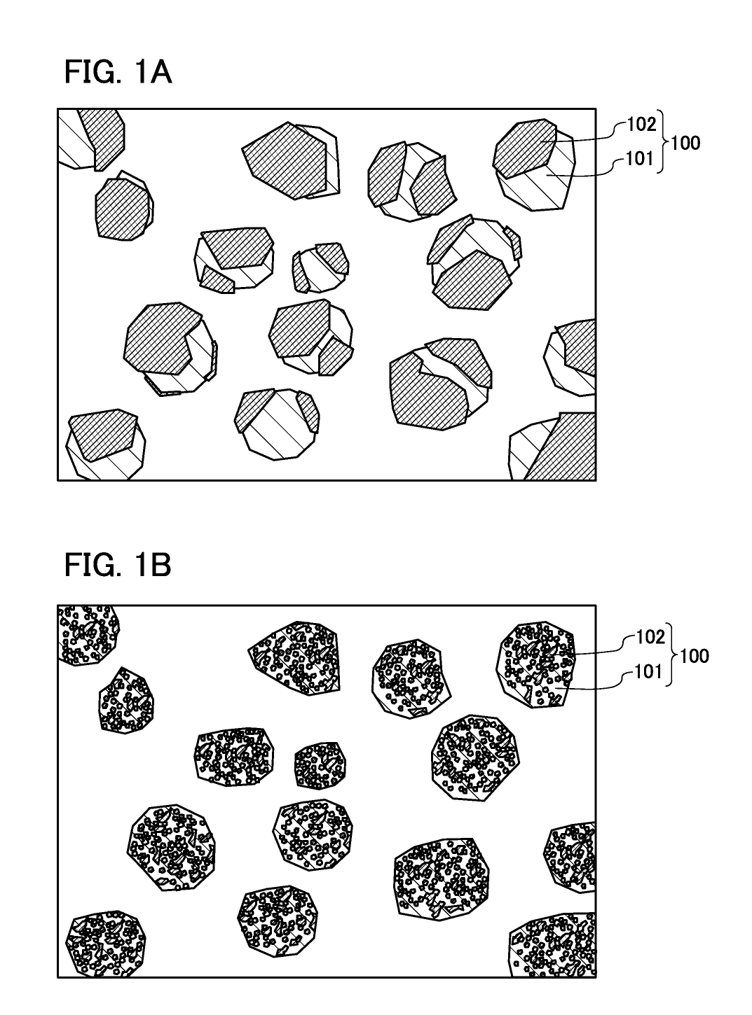

In this embodiment, an electrode material for a power storage device of one embodiment of the present invention will be described with reference to FIGS. 1A and 1B.

FIGS. 1A and 1B each illustrate electrode materials 100 for a power storage device of one embodiment of the present invention. The electrode materials 100 for a power storage device each include an active material particle 101 and a coating film 102 covering part of the surface of the active material particle 101. Here, “particle” is used to indicate the exterior shape of an active material having a given surface area, such as a spherical shape (powder shape), a plate shape, a horn shape, a columnar shape, a needle shape, or a flake shape. The active material particles 101 do not necessarily have to be in spherical shapes and the particles may have given shapes different from each other. A method for forming the active material particles 101 is not particularly limited as long as the active material particles 101 can have any of the above shapes.

There is no particular limitation on the average diameter of the active material particles 101; active material particles with general average diameter or diameter distribution are used. In the case where the active material particles 101 are negative electrode active material particles used for a negative electrode, negative electrode active material particles with an average diameter in the range from 1 μm to 50 μm, for example, can be used. In the case where the active material particles 101 are positive electrode active material particles used for a positive electrode and each of the positive electrode active material particles is a secondary particle, the average diameter of primary particles composing the secondary particle can be in the range from 10 nm to 1 μm.

As a negative electrode active material, graphite, which is a carbon material generally used in the field of power storage, can be used. Examples of graphite include low crystalline carbon such as soft carbon and hard carbon and high crystalline carbon such as natural graphite, kish graphite, pyrolytic carbon, mesophase pitch based carbon fiber, mesocarbon microbeads (MCMB), mesophase pitches, petroleum-based and coal-based coke, and the like.

As the negative electrode active material, other than the above carbon materials, an alloy-based material which enables charge-discharge reaction by alloying and dealloying reaction with carrier ions can be used. For example, a material containing at least one of Mg, Ca, Al, Si, Ge, Sn, Pb, As, Sb, Bi, Ag, Au, Zn, Cd, Hg, In, etc. can be used as a lithium alloy. Such metals have higher capacity than carbon. In particular, silicon has a significantly high theoretical capacity of 4200 mAh/g. For this reason, silicon is preferably used as the negative electrode active material.

For a positive electrode active material, a material into and from which carrier ions can be inserted and extracted is used. For example, a compound such as LiFeO₂, LiCoO₂, LiNiO₂, LiMn₂O₄, V₂O₅, Cr₂O₅, and MnO₂ can be used.

Alternatively, a complex material (LiMPO₄ (general formula) (M is one or more of Fe(II), Mn(II), Co(II), and Ni(II))) can be used. Typical examples of the general formula LiMPO₄ which can be used as a material are lithium compounds such as LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≦1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≦1, 0<c<1, 0<d<1, and 0<e<1), and LiFeᵣNi_{q}CoₕMnᵢPO₄ (f+g+h+i≦1, 0<f<1, 0<g<1, 0<h<1, and 0<i<1).

Alternatively, a complex material such as Li₍₂₋ⱼ₎MSiO₄ (general formula) (M is one or more of Fe(II), Mn(II), Co(II), and Ni(II); 0≦j≦2) may be used. Typical examples of the general formula Li₍₂₋ⱼ₎MSiO₄ which can be used as a material are lithium compounds such as Li₍₂₋ⱼ₎FeSiO₄, Li₍₂₋ⱼ₎CoSiO₄, Li₍₂₋ⱼ₎MnSiO₄, Li₍₂₋ⱼ₎FeₖNiₗSiO₄, Li₍₂₋ⱼ₎FeₖCoₗSiO₄, Li₍₂₋ⱼ₎FeₖMnₗSiO₄, Li₍₂₋ⱼ₎NiₖCoₗSiO₄, Li₍₂₋ⱼ₎NiₖMnₗSiO₄ (k+l≦1, 0<k<1, and 0<l<1), Li₍₂₋ⱼ₎FeₘNiₙCo_{q}SiO₄, Li₍₂₋ⱼ₎FeₘNiₙMn_{q}SiO₄, Li₍₂₋ⱼ₎NiₘCoₙMn_{q}SiO₄ (m+n+q≦1, 0<m<1, 0<n<1, and 0<q<1), and Li₍₂₋ⱼ₎FeᵣNiₛCoₜMnᵤSiO₄ (r+s+t+u≦1, 0<r<1, 0<s<1, 0<t<1, and 0<u<1).

Examples of carrier ions used for a power storage device are lithium ions, which are a typical example thereof; alkali-metal ions other than lithium ions; alkaline-earth metal ions; beryllium ions; magnesium ions; and the like. In the case where ions other than lithium ions are used as carrier ions, the following may be used as the positive electrode active material: a compound which is obtained by substituting an alkali metal (e.g., sodium or potassium), an alkaline-earth metal (e.g., calcium, strontium, barium, beryllium, or magnesium) for lithium in any of the above lithium compounds and a composite of the obtained compounds.

Coating films 102 are formed on the surface of the active material particle 101. As illustrated in FIG. 1A, the coating films 102 do not entirely cover the surface of the active material particle 101 but partly cover the surface. In other words, the surface of the active material particle 101 has a region covered with the coating film 102 and a region not covered with the coating film 102. In addition, the coating films 102 covering the active material particle 101 may each have a relatively large surface covering a few percent to dozens of percent of the surface area of the active material particle 101 as illustrated in FIG. 1A or a surface with a very small area as illustrated in FIG. 1B. It is particularly preferable that the surface of the active material particle which is in contact with an electrolytic solution and is other than a portion in contact with members of an electrode, such as adjacent active material particles, a binder, and a conductive additive, be entirely covered with the coating films 102. The size of the coating film 102 provided on the surface of the active material particle 101 can be appropriately adjusted in accordance with conditions which depend on a formation method of the coating film, such as a sol-gel method described later, the shape or state of the surface of the active material particle 101 which is used, or the like.

As a material of the coating film 102, an oxide film of any one of niobium, titanium, vanadium, tantalum, tungsten, zirconium, molybdenum, hafnium, chromium, aluminum, and silicon and an oxide film containing any one of these elements and lithium can be used. Alternatively, a polymer such as poly(ethylene oxide) (PEO) having permeability to carrier ions such as lithium ions may be used for the coating film 102. The coating film 102 formed using such a material has less pores than a conventional surface film formed on the surface of an active material due to decomposition of an electrolytic solution.

Thus, when the coating film 102 covering the active material particle 101 has carrier ion conductivity, carrier ions can pass through the coating film 102, so that the battery reaction of the active material particle 101 can occur. On the other hand, when the coating film 102 has an insulating property, the reaction between an electrolytic solution and the active material particle 101 can be suppressed.

Here, assume that the product of the electric resistivity and the thickness of the coating film 102 at 25° C. is greater than or equal to 20 Ωm·m, preferably greater than or equal to 200 Ωm·m. When the product of the electric resistivity and the thickness of the coating film 102 at 25° C. is greater than or equal to 20 Ωm·m, the decomposition reaction between the active material particle 101 and an electrolytic solution can be reduced. Further, when the product of the electric resistivity and the thickness of the coating film 102 at 25° C. is greater than or equal to 200 Ωm·m, the decomposition reaction between the active material particle 101 and an electrolytic solution can be suppressed.

Under the above condition, irreversible capacity, which causes a decrease in the initial capacity of a power storage device, can be reduced and the electrochemical decomposition of an electrolytic solution and the like can be reduced or suppressed. Further, the decomposition reaction of an electrolytic solution and the like, which is caused as a side reaction of charge and discharge of a power storage device, can be reduced or suppressed, and thus the cycle performance of the power storage device can be improved. Furthermore, the decomposition reaction of an electrolytic solution, which is accelerated at high temperature, is reduced or suppressed and a decrease in charge and discharge capacity in charging and discharging at high temperature is prevented, so that the operating temperature range of a power storage device can be extended.

The upper limit of the product of the electric resistivity and the thickness of the coating film 102 at 25° C. is a value with which carrier ions used for a power storage device can pass through the coating film 102, and the value depends on a material of the coating film 102.

When the active material particle 101 is entirely isolated electrically, electrons cannot transfer between inside and outside the active material particle 101; thus, a battery reaction cannot occur. Therefore, to ensure a path for electron conduction with the outside, the active material particle 101 needs to be prevented from being completely covered with the coating films 102 and at least part of the active material particle 101 needs to be exposed. The coating films 102 covering part of the active material particle 101 are formed on the surface of the active material particle 101 in such a manner, whereby the battery reaction of the active material particle 101 can occur and the decomposition reaction of an electrolytic solution can be suppressed.

This embodiment can be implemented in combination with any of the other embodiments and the example as appropriate.

### Embodiment 2

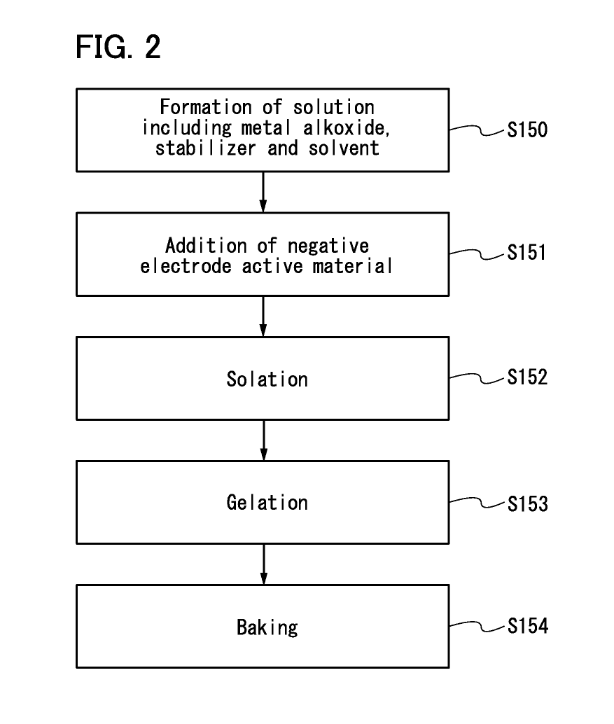

In this embodiment, as an example of a manufacturing method of the electrode material for a power storage device, which is described in Embodiment 1, a manufacturing method in which a coating film is formed on the surface of an active material by a sol-gel process will be described with reference to FIG. 2.

First, in Step S150, a solvent to which metal alkoxide and a stabilizer are added is stirred to form a solution. Toluene can be used as the solvent, for example. Ethyl acetoacetate can be used as the stabilizer, for example.

For the metal alkoxide, a metal alkoxide is used to form a metal oxide as a precursor for sol-gel synthesis. For example, when a niobium oxide film is formed as the coating film, niobium ethoxide (Nb(OEt)₅) can be used as metal alkoxide. Alternatively, when a silicon oxide film is formed as the coating film, silicon ethoxide (Si(OEt)₄) can be used as metal alkoxide.

Next, in Step S151, the solution to which active material particles are added is stirred. A solvent such as toluene is added to the obtained solution and the mixture is stirred to form thick paste, and the surface of the active material is covered with metal alkoxide. Step S150 and Step S151 are preferably performed in an environment at a low humidity, such as a dry room. This is because a hydrolysis reaction can be suppressed.

Next, in Step S152 and Step S153, the metal alkoxide on the surfaces of the active material particles is changed into a gel by a sol-gel process.

In Step S152, a small amount of water is added to the solution to which the active material particles are added, so that the metal alkoxide reacts with the water (i.e., hydrolysis reaction) to form a decomposition product which is a sol. Here, the term “being a sol” refers to being in the state where solid fine particles are substantially uniformly dispersed in a liquid. The small amount of water may be added by exposing the solution to which the active material is added to the air. For example, in the case where niobium ethoxide (Nb(OEt)₅) is used as the metal alkoxide, the hydrolysis reaction represented by Equation 1 occurs. Alternatively, in the case where silicon ethoxide (Si(OEt)₄) is used as the metal alkoxide, the hydrolysis reaction represented by Equation 2 occurs.

Nb(OEt)₅+5EtOH→Nb(OEt)₅₋ₓ(OH)ₓ+xEtOH (x is a positive number of 5 or less) [Equation 1]

Si(OEt)₄+4H₂O→Si(OEt)₄₋ₓ(OH)ₓ+EtOH (x is a positive number of 4 or less) [Equation 2]

Next, in Step S153, the decomposition product, which is the sol, is subjected to dehydration condensation to form a substance which is a gel through the reaction. Here, “being a gel” refers to being in the state where a three-dimensional network structure is developed due to attractive interaction between solid fine particles, whereby a decomposition product is solidified. In the case where niobium ethoxide (Nb(OEt)₅) is used as the metal alkoxide, the condensation reaction equation is described as Equation 3. Alternatively, in the case where silicon ethoxide (Si(OEt)₄) is used, the condensation reaction equation is described as Equation 4.

2nNb(OEt)₅₋ₓ(OH)ₓ→nNb₂[(OEt)₃₋ₓ(OH)ₓ₋₁]₂+H₂O (x is a positive number of 5 or less) [Equation 3]

2nSi(OEt)₄₋ₓ(OH)ₓ₋₁→(OEt)₄₋ₓ(OH)ₓ₋₁Si—O—Si(OH)ₓ₋₁(OEt)₄₋ₓ (x is a positive number of 4 or less) [Equation 4]

In this step, the substance which is a gel attached to the surfaces of the active material particles may be formed through a sol-gel method. Note that although solation by the hydrolysis reaction and gelation by the condensation reaction are separately described above as two steps, Steps S152 and S153, for convenience, both the reactions occur almost at the same time in practice. This is because the structure of metal alkoxide gradually changes into that of a stable substance which is a gel, depending on conditions of temperature and water.

Then, in Step S154, the dispersion is baked under an atmospheric pressure, whereby the active material particles with metal oxide films attached on the surfaces thereof can be obtained. The temperature for the baking is higher than or equal to 300° C. and lower than or equal to 900° C., preferably higher than or equal to 500° C. and lower than or equal to 800° C.

Through the above steps, an active material covered with a coating film formed of a metal oxide film is formed. In the case of forming a coating film on an active material by a sol-gel method in such a manner, the above steps can be employed even for an active material having a complicated shape, and a large number of coating films can be formed; therefore, the sol-gel method is an optimal method for a mass production process.

This embodiment can be implemented in combination with any of the other embodiments and the example as appropriate.

### Embodiment 3

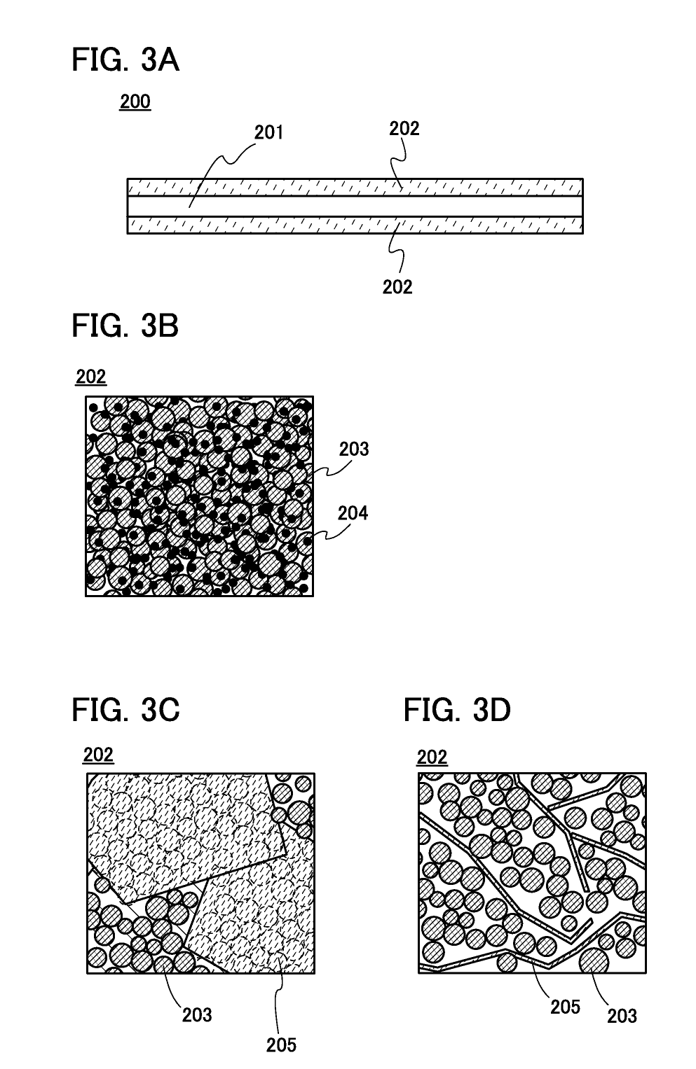

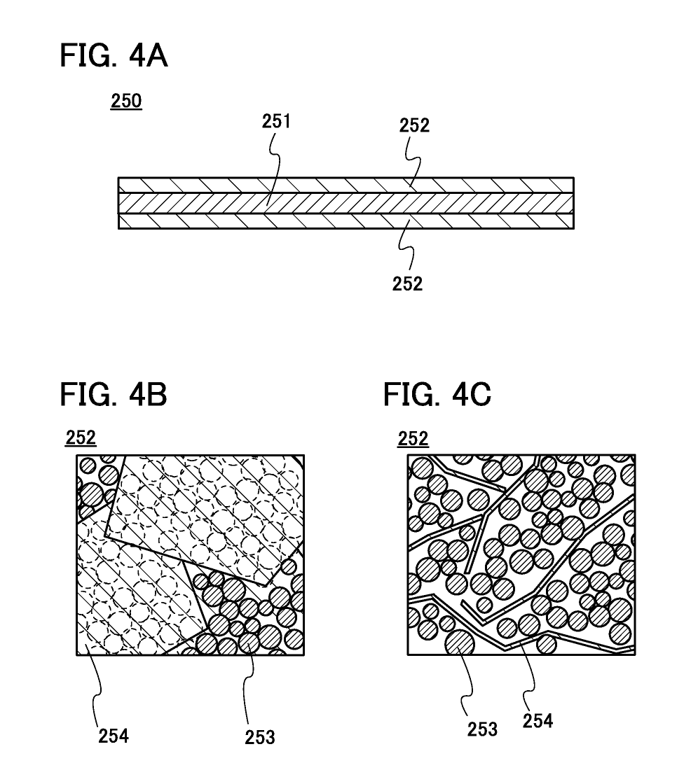

In this embodiment, an electrode for a power storage device which is formed using active material particles provided with coating films and a formation method of the electrode will be described with reference to FIGS. 3A to 3D and FIGS. 4A to 4C.

### (Negative Electrode)

FIGS. 3A to 3D illustrate an electrode (negative electrode) for a power storage device in which an electrode material for a power storage device includes negative electrode active material particles. As illustrated in FIG. 3A, a negative electrode 200 includes a negative electrode current collector 201 and a negative electrode active material layer 202 provided over one of surfaces of the negative electrode current collector 201 or negative electrode active material layers 202 provided so that the negative electrode current collector 201 is sandwiched therebetween. In the drawing, the negative electrode active material layers 202 are provided so that the negative electrode current collector 201 is sandwiched therebetween.

The negative electrode current collector 201 is formed using a highly conductive material which is less likely to chemically react with carrier ions such as lithium ions. For example, stainless steel, iron, copper, nickel, or titanium can be used. Alternatively, an alloy material such as an aluminum-nickel alloy or an aluminum-copper alloy may be used. The negative electrode current collector 201 can have a foil shape, a plate shape (sheet shape), a net shape, a punching-metal shape, an expanded-metal shape, or the like as appropriate. The negative electrode current collector 201 preferably has a thickness in the range from 10 μm to 30 μm.

The negative electrode active material layer 202 is provided over one of surfaces of the negative electrode current collector 201. Alternatively, the negative electrode active material layers 202 are provided so that the negative electrode current collector 201 is sandwiched therebetween. For the negative electrode active material layer 202, the negative electrode active material particles covered with coating films, which are described in Embodiment 1 or 2, are used.

In this embodiment, the negative electrode active material layer 202 formed by mixing and drying the above negative electrode active material, a binder, and a conductive additive is used. Note that a conductive additive is added as needed; it does not necessarily have to be added.

Note that the negative electrode active material layer 202 does not necessarily have to be formed on and in direct contact with the negative current collector 201. Any of the following functional layers may be formed using a conductive material such as a metal between the negative electrode current collector 201 and the negative electrode active material layer 202: an adhesion layer for increasing the adhesion between the negative electrode current collector 201 and the negative electrode active material layer 202; a planarization layer for reducing the roughness of the surface of the negative electrode current collector 201; a heat radiation layer; a stress relaxation layer for reducing the stress on the negative electrode current collector 201 or the negative electrode active material layer 202; and the like.

The negative electrode active material layer 202 will be described with reference to FIG. 3B. FIG. 3B is a cross-sectional view of part of the negative electrode active material layer 202. The negative electrode active material layer 202 includes negative electrode active material particles 203 which correspond to those described in Embodiment 1 or 2, a binder (not illustrated), and a conductive additive 204. The negative electrode active material particle 203 is covered with coating films in the manner described in the above embodiment.

As the binder, any material can be used as long as it can bind the negative electrode active material, the conductive additive, and the current collector. For example, any of the following can be used as the binder: resin materials such as poly(vinylidene fluoride) (PVDF), a vinylidene fluoride-hexafluoropropylene copolymer, a vinylidene fluoride-tetrafluoroethylene copolymer, styrene-butadiene copolymer rubber, polytetrafluoroethylene, polypropylene, polyethylene, and polyimide.

The conductive additive 204 improves conductivity between the negative electrode active material particles 203 and between the negative electrode active material particle 203 and the negative electrode current collector 201 and thus can be added to the negative electrode active material layer 202. As the conductive additive 204, a material which has a large specific surface area is preferably used; for example, acetylene black (AB) can be used. Alternatively, a carbon material such as a carbon nanotube, graphene, fullerene, or Ketjen black can be used. Note that an example where graphene is used will be described below.

The negative electrode 200 is formed in the following manner. First, negative electrode active material particles provided with coating films which are formed by the method described in Embodiment 2 are mixed into a solvent such as NMP (N-methylpyrrolidone) in which a vinylidene fluoride-based polymer such as poly(vinylidene fluoride) or the like is dissolved to form slurry.

Then, the slurry is applied to one of or both the surfaces of the negative electrode current collector 201, and dried. In the case where both the surfaces of the negative electrode current collector 201 are subjected to the coating step, the negative electrode active material layers 202 are formed so that the negative electrode current collector 201 is sandwiched therebetween at the same time or one by one. After that, rolling with a roller press machine is performed, whereby the negative electrode 200 is formed.

Next, an example where graphene is added to the negative electrode active material layer 202 will be described with reference to FIGS. 3C and 3D.

Graphene serves as a conductive additive which forms an electron conducting path between active materials and between an active material and a current collector.

Note that graphene in this specification includes single-layer graphene and multilayer graphene including two to hundred layers. Single-layer graphene refers to a one-atom-thick sheet of carbon molecules having π bonds. When graphene oxide is reduced to form graphene, oxygen contained in the graphene oxide is not entirely released and part of the oxygen remains in the graphene. When the graphene contains oxygen, the proportion of the oxygen is higher than or equal to 2 at. % and lower than or equal to 20 at. % of the whole graphene, preferably higher than or equal to 3 at. % and lower than or equal to 15 at. % of the whole graphene, which is measured by X-ray photoelectron spectroscopy (XPS). Note that graphene oxide refers to a compound formed by oxidizing the graphene.

FIG. 3C is a plan view of a part of the negative electrode active material layer 202 formed using graphene. The negative electrode active material layer 202 includes negative electrode active material particles 203 and graphenes 205 which cover a plurality of the negative electrode active material particles 203 and at least partly surround the plurality of the negative electrode active material particles 203. Although a binder not illustrated may be added, when graphenes 205 are included so as to be bonded to each other to fully function as a binder, a binder does not necessarily have to be added. The different graphenes 205 cover surfaces of the plurality of the negative electrode active material particles 203 in the negative electrode active material layer 202 in the plan view. The negative electrode active material particles 203 may partly be exposed.

FIG. 3D is a cross-sectional view of the part of the negative electrode active material layer 202 in FIG. 3C. FIG. 3D illustrates the negative electrode active material particles 203 and the graphenes 205 covering a plurality of the negative electrode active material particles 203 in the negative electrode active material layer 202 in the plan view. The graphenes 205 are observed to have linear shapes in the cross-sectional view. One graphene or a plurality of the graphenes overlap with a plurality of the negative electrode active material particles 203, or the plurality of the negative electrode active material particles 203 are at least partly surrounded with one graphene or a plurality of the graphenes. Note that the graphene 205 has a bag-like shape, and a plurality of the negative electrode active materials are at least partly surrounded with the graphene in some cases. The graphene 205 partly has openings where the negative electrode active material particles 203 are exposed in some cases.

The desired thickness of the negative electrode active material layer 202 is determined in the range from 20 μm to 200 μm.

The negative electrode active material layer 202 may be predoped with lithium in such a manner that a lithium layer is formed on a surface of the negative electrode active material layer 202 by a sputtering method. Alternatively, lithium foil is provided on the surface of the negative electrode active material layer 202, whereby the negative electrode active material layer 202 can be predoped with lithium.

An example of the negative electrode active material particle 203 is a material whose volume is expanded by reception of carrier ions. When such a material is used, the negative electrode active material layer gets vulnerable and is partly collapsed by charge and discharge, resulting in lower reliability (e.g., inferior cycle characteristics) of a power storage device.

However, the graphene 205 covering the periphery of the negative electrode active material particles 203 can prevent dispersion of the negative electrode active material particles and the collapse of the negative electrode active material layer, even when the volume of the negative electrode active material particles is increased and decreased due to charge and discharge. That is to say, the graphene 205 has a function of maintaining the bond between the negative electrode active material particles even when the volume of the negative electrode active material particles is increased and decreased by charge and discharge. For this reason, a binder does not have to be used in forming the negative electrode active material layer 202. Thus, the proportion of the negative electrode active material particles per unit weight (unit volume) of the negative electrode active material layer 202 can be increased, leading to an increase in charge and discharge capacity per unit weight (unit volume) of the electrode.

The graphene 205 has conductivity and is in contact with a plurality of the negative electrode active materials particles 203; thus, it also serves as a conductive additive. For this reason, a conductive additive does not have to be used in forming the negative electrode active material layer 202. Accordingly, the proportion of the negative electrode active material particles in the negative electrode active material layer 202 with certain weight (certain volume) can be increased, leading to an increase in charge and discharge capacity per unit weight (unit volume) of the electrode.

The graphene 205 efficiently forms a sufficient electron conductive path in the negative electrode active material layer 202, so that the conductivity of the negative electrode 200 can be increased.

The graphene 205 also functions as a negative electrode active material, leading to an increase in charge and discharge capacity of the negative electrode 200.

Next, a formation method of the negative electrode active material layer 202 in FIGS. 3C and 3D will be described.

First, the negative electrode active material particles 203 provided with coating films which are formed as in Embodiment 1 or 2 and a dispersion containing graphene oxide are mixed to form slurry.

Then, the slurry is applied to the negative electrode current collector 201. Next, drying is performed in a vacuum for a certain period of time to remove a solvent from the slurry applied to the negative electrode current collector 201. After that, rolling with a roller press machine is performed.

Then, the graphene oxide is electrochemically reduced with electric energy or thermally reduced by heat treatment to form the graphene 205. Particularly in the case where electrochemical reduction treatment is performed, the proportion of π bonds of graphene formed by the electrochemical reduction treatment is higher than that of graphene formed by heat treatment; therefore, the graphene 205 having high conductivity can be formed. Through the above process, the negative electrode active material layer 202 including graphene as a conductive additive can be formed over one of the surfaces of the negative electrode current collector 201 or the negative electrode active material layers 202 can be formed so that the negative electrode current collector 201 is sandwiched therebetween, whereby the negative electrode 200 can be formed.

### (Positive Electrode)

FIGS. 4A to 4C illustrate an electrode (positive electrode) for a power storage device in which an electrode material for a power storage device includes positive electrode active material particles. FIG. 4A is a cross-sectional view of a positive electrode 250. In the positive electrode 250, positive electrode active material layers 252 are formed so that a positive electrode current collector 251 is sandwiched therebetween, or although not illustrated, the positive electrode active material layer 252 is formed over one of surfaces of the positive electrode current collector 251.

For the positive electrode current collector 251, a highly conductive material such as a metal typified by stainless steel, gold, platinum, zinc, iron, copper, aluminum, or titanium, or an alloy thereof can be used. Alternatively, an aluminum alloy to which an element which improves heat resistance, such as silicon, titanium, neodymium, scandium, or molybdenum, is added can be used. Still alternatively, a metal element which forms silicide by reacting with silicon can be used. Examples of the metal element which forms silicide by reacting with silicon include zirconium, titanium, hafnium, vanadium, niobium, tantalum, chromium, molybdenum, tungsten, cobalt, nickel, and the like. The positive electrode current collector 251 can have a foil-like shape, a plate-like shape (sheet-like shape), a net-like shape, a punching-metal shape, an expanded-metal shape, or the like as appropriate.

The positive electrode active material layer 252 is provided over one of surfaces of the positive electrode current collector 251. Alternatively, the positive electrode active material layers 252 are provided so that the positive electrode current collector 251 is sandwiched therebetween. For the positive electrode active material layer 252, the positive electrode active material particles covered with coating films, which are described in Embodiment 1 or 2, are used.

In addition to the positive electrode active material particles, a conductive additive and a binder may be included in the positive electrode active material layer 252.

Note that the positive electrode active material layer 252 does not necessarily have to be formed on and in direct contact with the positive electrode current collector 251. Any of the following functional layers may be formed using a conductive material such as a metal between the positive electrode current collector 251 and the positive electrode active material layer 252: an adhesion layer for increasing the adhesion between the positive electrode current collector 251 and the positive electrode active material layer 252; a planarization layer for reducing the roughness of the surface of the positive electrode current collector 251; a heat radiation layer; a stress relaxation layer for reducing the stress on the positive electrode current collector 251 or the positive electrode active material layer 252; and the like.

The positive electrode active material layer 252 will be described with reference to FIGS. 4B and 4C. FIG. 4B is a plan view of part of the positive electrode active material layer 252 including graphene. The positive electrode active material layer 252 includes positive electrode active material particles 253 which correspond to those described in Embodiment 1 or 2, graphenes 254, and a binder (not illustrated). The positive electrode active material particle 253 is covered with coating films in the manner described in the above embodiment. The graphenes 254 cover a plurality of the positive electrode active material particles 253 and at least partly surround the plurality of the positive electrode active material particles 253. Part of the surfaces of the plurality of the positive electrode active material particles 253 is covered with different graphenes 254, and the rest part thereof is exposed.

In the case where the positive electrode active material particle 253 is a secondary particle, the average diameter of primary particles composing the secondary particle can be in the range from 10 nm to 1 μm. Note that the size of the positive electrode active material particle 253 is preferably smaller because electrons transfer in the positive electrode active material particles 253.

When the surfaces of the positive electrode active material particles 253 are provided with carbon layers, the conductivity of the positive electrode active material layer 252 can be increased. In this case, coating films are preferably formed on surfaces of the carbon layers. Sufficient characteristics can be obtained even when the positive electrode active material particles 253 are not covered with carbon layers; however, it is preferable to use the graphenes 254 and the positive electrode active material particles 253 covered with carbon layers because current flows.

FIG. 4C is a cross-sectional view of the part of the positive electrode active material layer 252 in FIG. 4B. The positive electrode active material layer 252 includes the positive electrode active material particles 253 and the graphenes 254 which cover a plurality of the positive electrode active material particles 253. The graphenes 254 are observed to have linear shapes in the cross-sectional view. A plurality of the positive electrode active material particles are at least partly surrounded with one graphene or a plurality of the graphenes or sandwiched between a plurality of the graphenes. Note that the graphene has a bag-like shape, and a plurality of the positive electrode active material particles are surrounded with the graphene in some cases. In addition, part of the positive electrode active material particles is not covered with the graphenes 254 and exposed in some cases.

The desired thickness of the positive electrode active material layer 252 is determined to be greater than or equal to 20 μm and less than or equal to 200 μm. It is preferable to adjust the thickness of the positive electrode active material layer 252 as appropriate so that a crack and flaking are not caused.

Note that the positive electrode active material layer 252 may include acetylene black particles having a volume 0.1 times to 10 times as large as that of the graphene 254, carbon particles having a one-dimensional expansion such as carbon nanofibers, or other known conductive additives.

Depending on a material of the positive electrode active material particles 253, the volume is expanded by reception of ions serving as carriers. When such a material is used, the positive electrode active material layer gets vulnerable and is partly collapsed by charge and discharge, resulting in lower reliability of a power storage device. However, the graphene 254 covering the periphery of the positive electrode active material particles allows prevention of dispersion of the positive electrode active material particles and the collapse of the positive electrode active material layer, even when the volume of the positive electrode active material particles is increased and decreased due to charge and discharge. That is to say, the graphene 254 has a function of maintaining the bond between the positive electrode active material particles even when the volume of the positive electrode active material particles is increased and decreased by charge and discharge.

The graphene 254 is in contact with a plurality of the positive electrode active material particles and serves also as a conductive additive. Further, the graphene 254 has a function of holding the positive electrode active material particles 253 capable of receiving and releasing carrier ions. Thus, a binder does not have to be mixed into the positive electrode active material layer. Accordingly, the proportion of the positive electrode active material particles in the positive electrode active material layer can be increased, which allows an increase in charge and discharge capacity of a power storage device.

Next, a method for forming the positive electrode active material layers 252 will be described.

First, slurry containing positive electrode active material particles whose surfaces are provided with coating films, which is described in Embodiment 1 or 2, and graphene oxide is formed. Then, the slurry is applied to the positive electrode current collector 251. After that, heating is performed in a reducing atmosphere for reduction treatment so that the positive electrode active material particles are baked and part of oxygen is released from graphene oxide to form graphene. Note that to form the graphene 205, thermal reduction of graphene oxide, electrochemical reduction of graphene oxide with electric energy, chemical reduction of graphene oxide with a catalyst, or a combination of any of the above can be employed. Note that oxygen in the graphene oxide might not be entirely released and partly remains in the graphene.

Through the above steps, the positive electrode active material layers 252 can be provided so that the positive electrode current collector 251 is sandwiched therebetween. Consequently, the positive electrode active material layers 252 has higher conductivity.

Graphene oxide contains oxygen and thus is negatively charged in a polar liquid. As a result of being negatively charged, graphene oxide is dispersed in the polar liquid. Accordingly, the positive electrode active material particles contained in the slurry are not easily aggregated, so that the size of the positive electrode active material particle can be prevented from increasing. Thus, the transfer of electrons in the positive electrode active material particles is facilitated, resulting in an increase in conductivity of the positive electrode active material layer.

This embodiment can be implemented in combination with any of the other embodiments and the example as appropriate.

### Embodiment 4

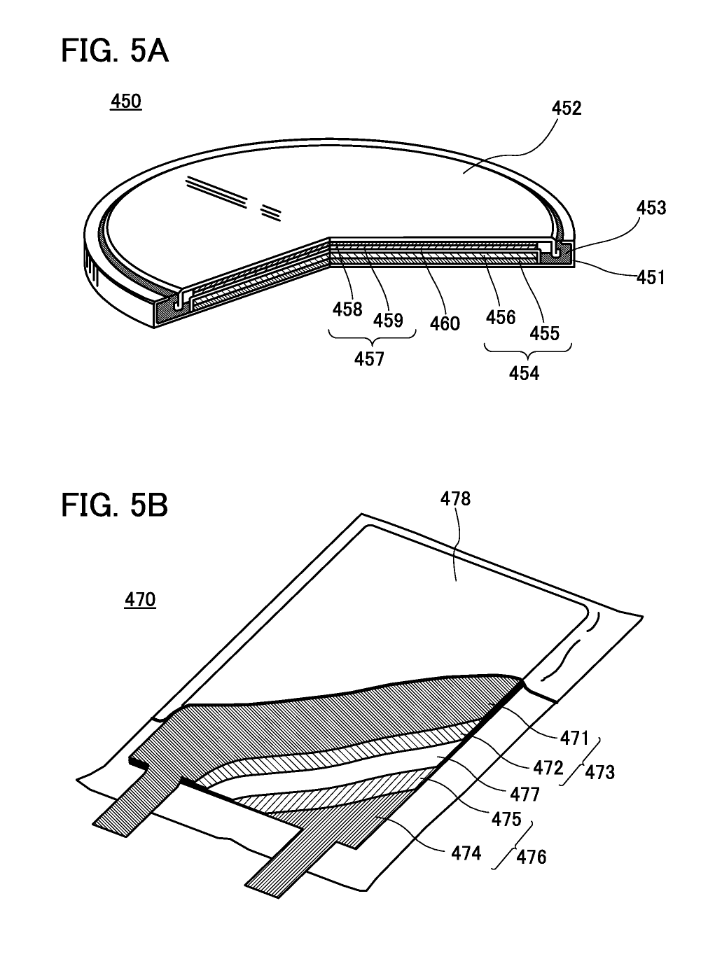

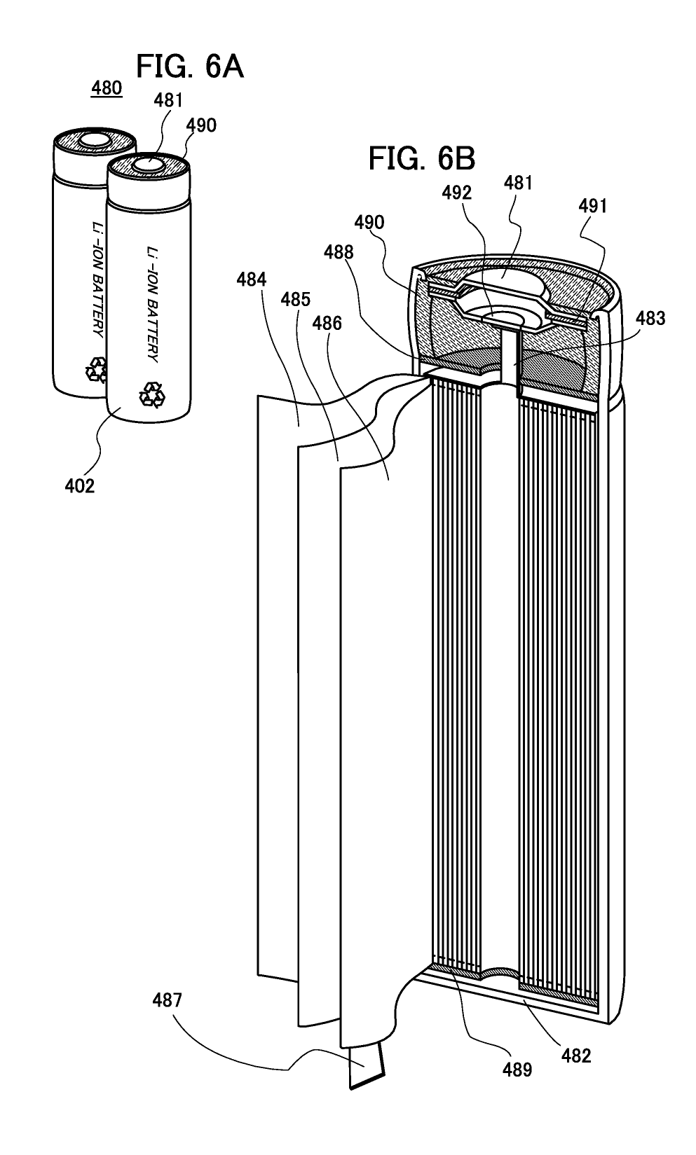

In this embodiment, a variety of power storage devices each including the electrode for a power storage device, which is described in Embodiment 3, will be described with reference to FIGS. 5A and 5B and FIGS. 6A and 6B.

### (Coin-Type Secondary Battery)

FIG. 5A is an external view of a coin-type (single-layer flat type) lithium-ion secondary battery, part of which illustrates a cross-sectional view of part of the coin-type lithium-ion secondary battery.

In a coin-type secondary battery 450, a positive electrode can 451 doubling as a positive electrode terminal and a negative electrode can 452 doubling as a negative electrode terminal are insulated from each other and sealed by a gasket 453 made of polypropylene or the like. A positive electrode 454 includes a positive electrode current collector 455 and a positive electrode active material layer 456 provided in contact with the positive electrode current collector 455. A negative electrode 457 includes a negative electrode current collector 458 and a negative electrode active material layer 459 provided in contact with the negative electrode current collector 458. A separator 460 and an electrolytic solution (not illustrated) are provided between the positive electrode active material layer 456 and the negative electrode active material layer 459.

As at least one of the positive electrode 454 and the negative electrode 457, the electrode for a power storage device of one embodiment of the present invention is used.

The negative electrode 457 includes the negative electrode active material layer 459 over the negative electrode current collector 458. The positive electrode 454 includes the positive electrode active material layer 456 over the positive electrode current collector 455. The active material of one embodiment of the present invention is used for the negative electrode active material layer 459 or the positive electrode active material layer 456.

Next, as the separator 460, a porous insulator such as cellulose (paper), polypropylene (PP), polyethylene (PE), polybutene, nylon, polyester, polysulfone, polyacrylonitrile, polyvinylidene fluoride, or tetrafluoroethylene can be used. Alternatively, nonwoven fabric of a glass fiber or the like, or a diaphragm in which a glass fiber and a polymer fiber are mixed may be used.

As a solvent for the electrolytic solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio. When a gelled high-molecular material is used as the solvent for the electrolytic solution, safety against liquid leakage and the like is improved. Further, a secondary battery can be thinner and more lightweight. Typical examples of the gelled high-molecular material include a silicone gel, an acrylic gel, an acrylonitrile gel, polyethylene oxide, polypropylene oxide, a fluorine-based polymer, and the like. Alternatively, the use of one or more of ionic liquids (room temperature ionic liquids) which has non-flammability and non-volatility as the solvent for the electrolytic solution can prevent the secondary battery from exploding or catching fire even when the secondary battery internally shorts out or the internal temperature increases due to overcharging or the like.

As an electrolyte dissolved in the above solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂F₅SO₂)₂ can be used, or two or more of these lithium salts can be used in an appropriate combination in an appropriate ratio.

For the positive electrode can 451 and the negative electrode can 452, a metal having a corrosion-resistant property to a liquid such as an electrolytic solution in charging and discharging a secondary battery, such as nickel, aluminum, or titanium; an alloy of any of the metals; an alloy containing any of the metals and another metal (e.g., stainless steel); a stack of any of the metals; a stack including any of the metals and any of the alloys (e.g., a stack of stainless steel and aluminum); or a stack including any of the metals and another metal (e.g., a stack of nickel, iron, and nickel) can be used. The positive electrode can 451 and the negative electrode can 452 are electrically connected to the positive electrode 454 and the negative electrode 457, respectively.

The negative electrode 457, the positive electrode 454, and the separator 460 are immersed in the electrolytic solution. Then, as illustrated in FIG. 5A, the positive electrode 454, the separator 460, the negative electrode 457, and the negative electrode can 452 are stacked in this order with the positive electrode can 451 positioned at the bottom, and the positive electrode can 451 and the negative electrode can 452 are subjected to pressure bonding with the gasket 453 interposed therebetween. In such a manner, the coin-type secondary battery 450 can be fabricated.

### (Laminated Secondary Battery)

Next, an example of a laminated secondary battery will be described with reference to FIG. 5B. In FIG. 5B, a structure inside the laminated secondary battery is partly exposed for convenience.

A laminated secondary battery 470 illustrated in FIG. 5B includes a positive electrode 473 including a positive electrode current collector 471 and a positive electrode active material layer 472, a negative electrode 476 including a negative electrode current collector 474 and a negative electrode active material layer 475, a separator 477, an electrolytic solution (not illustrated), and an exterior body 478. The separator 477 is provided between the positive electrode 473 and the negative electrode 476 in the exterior body 478. The exterior body 478 is filled with the electrolytic solution. Although the one positive electrode 473, the one negative electrode 476, and the one separator 477 are used in FIG. 5B, the secondary battery may have a layered structure in which positive electrodes, negative electrodes, and separators are alternately stacked.

As at least one of the positive electrode 473 and the negative electrode 476, the electrode for a power storage device of one embodiment of the present invention is used. That is to say, for at least one of the positive electrode active material layer 472 and the negative electrode active material layer 475, the active material for a power storage device of one embodiment of the present invention is used.

For the electrolytic solution, an electrolyte and a solvent which are similar to those in the above coin-type secondary battery can be used.

In the laminated secondary battery 470 illustrated in FIG. 5B, the positive electrode current collector 471 and the negative electrode current collector 474 also function as terminals (tabs) for electrical contact with an external portion. For this reason, each of the positive electrode current collector 471 and the negative electrode current collector 474 is provided so as to be partly exposed on the outside of the exterior body 478.

As the exterior body 478 in the laminated secondary battery 470, for example, a laminate film having a three-layer structure where a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide resin, a polyester resin, or the like is provided as the outer surface of the exterior body over the metal thin film can be used. With such a three-layer structure, permeation of an electrolytic solution and a gas can be blocked and an insulating property and resistance to the electrolytic solution can be obtained.

### (Cylindrical Secondary Battery)

Next, an example of a cylindrical secondary battery will be described with reference to FIGS. 6A and 6B. As illustrated in FIG. 6A, a cylindrical secondary battery 480 includes a positive electrode cap (battery cap) 481 on the top surface and a battery can (outer can) 482 on the side surface and bottom surface. The positive electrode cap 481 and the battery can 482 are insulated from each other by a gasket (insulating gasket) 490.

FIG. 6B is a diagram schematically illustrating a cross section of the cylindrical secondary battery. Inside the battery can 482 having a hollow cylindrical shape, a battery element in which a strip-like positive electrode 484 and a strip-like negative electrode 486 are wound with a stripe-like separator 485 interposed therebetween is provided. Although not illustrated, the battery element is wound around a center pin. One end of the battery can 482 is close and the other end thereof is open.

As at least one of the positive electrode 484 and the negative electrode 486, the electrode for a power storage device of one embodiment of the present invention is used.

For the battery can 482, a metal having a corrosion-resistant property to a liquid such as an electrolytic solution in charging and discharging a secondary battery, such as nickel, aluminum, or titanium; an alloy of any of the metals; an alloy containing any of the metals and another metal (e.g., stainless steel); a stack of any of the metals; a stack including any of the metals and any of the alloys (e.g., a stack of stainless steel and aluminum); or a stack including any of the metals and another metal (e.g., a stack of nickel, iron, and nickel) can be used. Inside the battery can 482, the battery element in which the positive electrode, the negative electrode, and the separator are wound is interposed between a pair of insulating plates 488 and 489 which face each other.

Further, an electrolytic solution (not illustrated) is injected inside the battery can 482 provided with the battery element. For the electrolytic solution, an electrolyte and a solvent which are similar to those in the above coin-type secondary battery and the above laminated secondary battery can be used.

Since the positive electrode 484 and the negative electrode 486 of the cylindrical secondary battery are wound, active materials are formed on both sides of the current collectors. A positive electrode terminal (positive electrode current collecting lead) 483 is connected to the positive electrode 484, and a negative electrode terminal (negative electrode current collecting lead) 487 is connected to the negative electrode 486. Both the positive electrode terminal 483 and the negative electrode terminal 487 can be formed using a metal material such as aluminum. The positive electrode terminal 483 and the negative electrode terminal 487 are resistance-welded to a safety valve mechanism 492 and the bottom of the battery can 482, respectively. The safety valve mechanism 492 is electrically connected to the positive electrode cap 481 through a positive temperature coefficient (PTC) element 491. The safety valve mechanism 492 cuts off electrical connection between the positive electrode cap 481 and the positive electrode 484 when the internal pressure of the battery exceeds a predetermined threshold value. Further, the PTC element 491, which serves as a thermally sensitive resistor whose resistance increases as temperature rises, limits the amount of current by increasing the resistance, in order to prevent abnormal heat generation. Note that barium titanate (BaTiO₃)-based semiconductor ceramic or the like can be used for the PTC element.

Note that in this embodiment, the coin-type secondary battery, the laminated secondary battery, and the cylindrical secondary battery are given as examples of the secondary battery; however, any of secondary batteries with a variety of shapes, such as a sealed secondary battery and a square-type secondary battery, can be used. Further, a structure in which a plurality of positive electrodes, a plurality of negative electrodes, and a plurality of separators are stacked or wound may be employed.

This embodiment can be implemented in combination with any of the other embodiments and the example as appropriate.

### Embodiment 5

In this embodiment, a lithium-ion capacitor will be described as a power storage device.

A lithium-ion capacitor is a hybrid capacitor including a combination of a positive electrode of an electric double layer capacitor (EDLC) and a negative electrode of a lithium-ion secondary battery formed using a carbon material and is also an asymmetric capacitor where power storage principles of the positive electrode and the negative electrode are different from each other. The positive electrode enables charge and discharge by adsorption and desorption of charge carrying ions across electrical double layers as in the “electric double layer capacitor”, whereas the negative electrode enables charge and discharge by the redox reaction as in the “lithium ion battery”. A negative electrode in which lithium is received in a negative electrode active material such as a carbon material is used, whereby energy density is much higher than that of a conventional electric double layer capacitor whose negative electrode is formed using porous activated carbon.

In a lithium-ion capacitor, instead of the positive electrode active material layer in the lithium-ion secondary battery described in Embodiment 3, a material capable of reversibly having at least one of lithium ions and anions is used. Examples of such a material include active carbon, a conductive polymer, and a polyacenic semiconductor (PAS).

The lithium-ion capacitor has high charge and discharge efficiency which allows rapid charge and discharge and has a long life even when it is repeatedly used.

As a negative electrode active material of such a lithium-ion capacitor, the active material for a power storage device of one embodiment of the present invention is used. Thus, initial irreversible capacity is suppressed, so that a power storage device having improved cycle performance can be fabricated. Further, a power storage device having excellent high temperature characteristics can be fabricated.

This embodiment can be implemented in combination with any of the other embodiments and the example as appropriate.

### Embodiment 6

The power storage device of one embodiment of the present invention can be used for power supplies of a variety of electronic devices which can be operated with electric power.

Specific examples of electronic devices each utilizing the power storage device of one embodiment of the present invention are as follows: display devices of televisions, monitors, and the like, lighting devices, desktop personal computers and laptop personal computers, word processors, image reproduction devices which reproduce still images or moving images stored in recording media such as digital versatile discs (DVDs), portable or stationary music reproduction devices such as compact disc (CD) players and digital audio players, portable or stationary radio receivers, recording reproduction devices such as tape recorders and IC recorders (voice recorders), headphone stereos, stereos, remote controllers, clocks such as table clocks and wall clocks, cordless phone handsets, transceivers, cell phones, car phones, portable or stationary game machines, pedometers, calculators, portable information terminals, electronic notepads, e-book readers, electronic translators, audio input devices such as microphones, cameras such as still cameras and video cameras, toys, electric shavers, electric toothbrushes, high-frequency heating appliances such as microwave ovens, electric rice cookers, electric washing machines, electric vacuum cleaners, water heaters, electric fans, hair dryers, air-conditioning systems such as humidifiers, dehumidifiers, and air conditioners, dishwashers, dish dryers, clothes dryers, futon dryers, electric refrigerators, electric freezers, electric refrigerator-freezers, freezers for preserving DNA, flashlights, electric power tools, smoke detectors, and health equipment and medical equipment such as hearing aids, cardiac pacemakers, portable X-ray equipment, radiation counters, electric massagers, and dialyzers. Further, industrial equipment such as guide lights, traffic lights, meters such as gas meters and water meters, belt conveyors, elevators, escalators, industrial robots, wireless relay stations, base stations of cell phones, power storage systems, and power storage devices for leveling the amount of power supply and smart grid can be given. In addition, moving objects driven by electric motors using electric power from the power storage devices are also included in the category of electronic devices. Examples of the moving objects include electric vehicles (EV), hybrid electric vehicles (HEV) which include both an internal-combustion engine and a motor, plug-in hybrid electric vehicles (PHEV), tracked vehicles in which caterpillar tracks are substituted for wheels of these vehicles, agricultural machines, motorized bicycles including motor-assisted bicycles, motorcycles, electric wheelchairs, electric carts, boats, ships, submarines, aircrafts such as fixed-wing aircraft and rotary-wing aircraft, rockets, artificial satellites, space probes, rovers, and spacecrafts.

In the electronic devices, the power storage device of one embodiment of the present invention can be used as a main power supply for supplying enough electric power for almost the whole power consumption. Alternatively, in the electronic devices, the power storage device of one embodiment of the present invention can be used as an uninterruptible power supply which can supply electric power to the electronic devices when the supply of electric power from the main power supply or a commercial power supply is stopped. Still alternatively, in the electronic devices, the power storage device of one embodiment of the present invention can be used as an auxiliary power supply for supplying electric power to the electronic devices at the same time as the power supply from the main power supply or a commercial power supply.

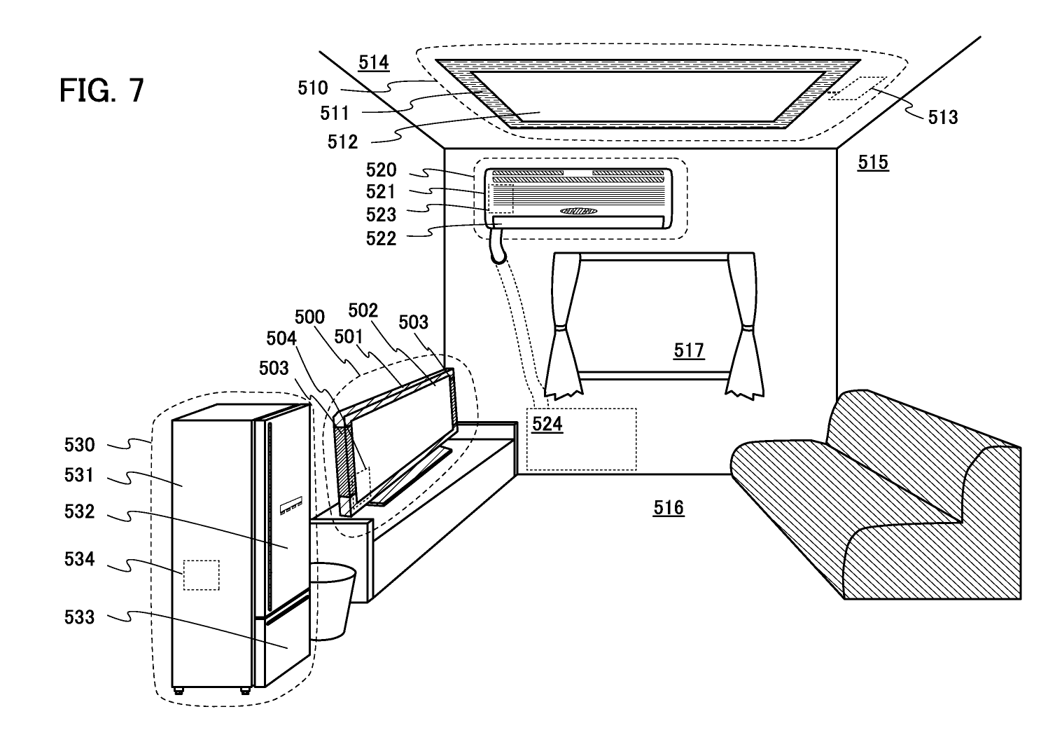

FIG. 7 illustrates specific structures of the electronic devices. In FIG. 7, a display device 500 is an example of an electronic device including a power storage device 504 of one embodiment of the present invention. Specifically, the display device 500 corresponds to a display device for TV broadcast reception and includes a housing 501, a display portion 502, speaker portions 503, and the power storage device 504. The power storage device 504 is provided in the housing 501. The display device 500 can receive electric power from a commercial power supply. Alternatively, the display device 500 can use electric power stored in the power storage device 504. Thus, the display device 500 can be operated with the use of the power storage device 504 as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a digital micromirror device (DMD), a plasma display panel (PDP), or a field emission display (FED) can be used for the display portion 502.

Note that the display device includes, in its category, all of information display devices for personal computers, advertisement displays, and the like besides TV broadcast reception.

In FIG. 7, a stationary lighting device 510 is an example of an electronic device including a power storage device 513 of one embodiment of the present invention. Specifically, the lighting device 510 includes a housing 511, a light source 512, and a power storage device 513. Although FIG. 7 illustrates the case where the power storage device 513 is provided in a ceiling 514 on which the housing 511 and the light source 512 are installed, the power storage device 513 may be provided in the housing 511. The lighting device 510 can receive electric power from a commercial power supply. Alternatively, the lighting device 510 can use electric power stored in the power storage device 513. Thus, the lighting device 510 can be operated with the use of the power storage device 513 as an uninterruptible power supply even when electric power cannot be supplied from a commercial power supply due to power failure or the like.

Note that although the stationary lighting device 510 provided in the ceiling 514 is illustrated in FIG. 7 as an example, the power storage device can be used in a stationary lighting device provided in, for example, a wall 515, a floor 516, a window 517, or the like other than the ceiling 514. Alternatively, the power storage device can be used in a tabletop lighting device or the like.

As the light source 512, an artificial light source which emits light artificially by using electric power can be used. Specifically, an incandescent lamp, a discharge lamp such as a fluorescent lamp, and light-emitting elements such as an LED and an organic EL element are given as examples of the artificial light source.

In FIG. 7, an air conditioner including an indoor unit 520 and an outdoor unit 524 is an example of an electronic device including a power storage device 523 of one embodiment of the invention. Specifically, the indoor unit 520 includes a housing 521, an air outlet 522, and a power storage device 523. Although FIG. 7 illustrates the case where the power storage device 523 is provided in the indoor unit 520, the power storage device 523 may be provided in the outdoor unit 524. Alternatively, the power storage devices 523 may be provided in both the indoor unit 520 and the outdoor unit 524. The air conditioner can receive electric power from a commercial power supply. Alternatively, the air conditioner can use electric power stored in the power storage device 523. Particularly in the case where the power storage devices 523 are provided in both the indoor unit 520 and the outdoor unit 524, the air conditioner can be operated with the use of the power storage device 523 as an uninterruptible power supply even when electric power cannot be supplied from a commercial power supply due to power failure or the like.

Note that although the split-type air conditioner including the indoor unit and the outdoor unit is illustrated in FIG. 7 as an example, the power storage device of one embodiment of the present invention can be used in an air conditioner in which the functions of an indoor unit and an outdoor unit are integrated in one housing.

In FIG. 7, an electric refrigerator-freezer 530 is an example of an electronic device including a power storage device 534 of one embodiment of the present invention. Specifically, the electric refrigerator-freezer 530 includes a housing 531, a door for a refrigerator 532, a door for a freezer 533, and the power storage device 534. The power storage device 534 is provided in the housing 531 in FIG. 7. The electric refrigerator-freezer 530 can receive electric power from a commercial power supply. Alternatively, the electric refrigerator-freezer 530 can use electric power stored in the power storage device 534. Thus, the electric refrigerator-freezer 530 can be operated with the use of the power storage device 534 as an uninterruptible power supply even when electric power cannot be supplied from a commercial power supply due to power failure or the like.

Note that among the electronic devices described above, a high-frequency heating apparatus such as a microwave oven and an electronic device such as an electric rice cooker require high power in a short time. The tripping of a breaker of a commercial power supply in use of an electronic device can be prevented by using a power storage device as an auxiliary power supply for supplying electric power which cannot be supplied enough by a commercial power supply.

In addition, in a time period when electronic devices are not used, particularly when the proportion of the amount of electric power which is actually used to the total amount of electric power which can be supplied from a commercial power supply source (such a proportion referred to as a usage rate of electric power) is low, electric power can be stored in the power storage device, whereby the usage rate of electric power can be reduced in a time period when the electronic devices are used. For example, in the case of the electric refrigerator-freezer 530, electric power can be stored in the power storage device 534 in night time when the temperature is low and the door for a refrigerator 532 and the door for a freezer 533 are not often opened or closed. On the other hand, in daytime when the temperature is high and the door for a refrigerator 532 and the door for a freezer 533 are frequently opened and closed, the power storage device 534 is used as an auxiliary power supply; thus, the usage rate of electric power in daytime can be reduced.

This embodiment can be implemented in combination with any of the other embodiments and the example as appropriate.

### Embodiment 7

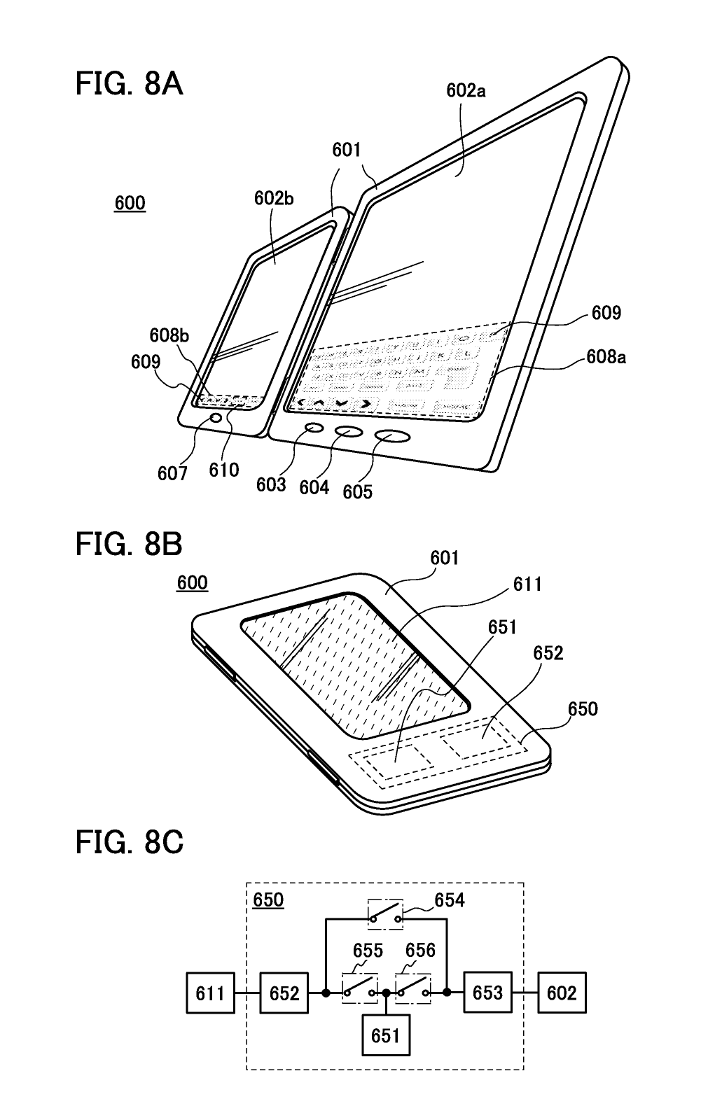

Next, a portable information terminal which is an example of portable electronic devices will be described with reference to FIGS. 8A to 8C.

FIGS. 8A and 8B illustrate a tablet terminal 600 which can be folded. FIG. 8A illustrates the tablet terminal 600 in the state of being unfolded. The tablet terminal includes a housing 601, a display portion 602a, a display portion 602b, a display-mode switching button 603, a power button 604, a power-saving-mode switching button 605, and an operation button 607.

A touch panel area 608a can be provided in part of the display portion 602a, in which area, data can be input by touching displayed operation keys 609. Note that half of the display portion 602a has only a display function and the other half has a touch panel function. However, the structure of the display portion 602a is not limited to this, and all the area of the display portion 602a may have a touch panel function. For example, a keyboard can be displayed on the whole display portion 602a to be used as a touch panel, and the display portion 602b can be used as a display screen.

A touch panel area 608b can be provided in part of the display portion 602b like in the display portion 602a. When a keyboard display switching button 610 displayed on the touch panel is touched with a finger, a stylus, or the like, a keyboard can be displayed on the display portion 602b.

The touch panel area 608a and the touch panel area 608b can be controlled by touch input at the same time.

The display-mode switching button 603 allows switching between a landscape mode and a portrait mode, color display and black-and-white display, and the like. The power-saving-mode switching button 605 allows optimizing the display luminance in accordance with the amount of external light in use which is detected by an optical sensor incorporated in the tablet terminal. In addition to the optical sensor, other detecting devices such as sensors for determining inclination, such as a gyroscope or an acceleration sensor, may be incorporated in the tablet terminal.

Although the display area of the display portion 602a is the same as that of the display portion 602b in FIG. 8A, one embodiment of the present invention is not particularly limited thereto. The display area of the display portion 602a may be different from that of the display portion 602b, and further, the display quality of the display portion 602a may be different from that of the display portion 602b. For example, one of the display portions 602a and 602b may display higher definition images than the other.

FIG. 8B illustrates the tablet terminal 600 in the state of being closed. The tablet terminal 600 includes the housing 601, a solar cell 611, a charge and discharge control circuit 650, a battery 651, and a DC-DC converter 652. FIG. 8B illustrates an example where the charge and discharge control circuit 650 includes the battery 651 and the DC-DC converter 652. The power storage device of one embodiment of the present invention, which is described in the above embodiment, is used as the battery 651.

Since the tablet terminal can be folded, the housing 601 can be closed when the tablet terminal is not in use. Thus, the display portions 602a and 602b can be protected, which permits the tablet terminal 600 to have high durability and improved reliability for long-term use.

The tablet terminal illustrated in FIGS. 8A and 8B can also have a function of displaying various kinds of data (e.g., a still image, a moving image, and a text image), a function of displaying a calendar, a date, the time, or the like on the display portion, a touch-input function of operating or editing data displayed on the display portion by touch input, a function of controlling processing by various kinds of software (programs), and the like.

The solar cell 611, which is attached on a surface of the tablet terminal, can supply electric power to a touch panel, a display portion, an image signal processor, and the like. Note that the solar cell 611 can be provided on one or both surfaces of the housing 601 and thus the battery 651 can be charged efficiently.

The structure and operation of the charge and discharge control circuit 650 illustrated in FIG. 8B will be described with reference to a block diagram of FIG. 8C. FIG. 8C illustrates the solar cell 611, the battery 651, the DC-DC converter 652, a converter 653, a switch 654, a switch 655, a switch 656, and a display portion 602. The battery 651, the DC-DC converter 652, the converter 653, and the switches 654 to 656 correspond to the charge and discharge control circuit 650 in FIG. 8B.

First, an example of operation in the case where electric power is generated by the solar cell 611 using external light will be described. The voltage of electric power generated by the solar cell is raised or lowered by the DC-DC converter 652 so that the electric power has a voltage for charging the battery 651. When the display portion 602 is operated with the electric power from the solar cell 611, the switch 654 is turned on and the voltage of the electric power is raised or lowered by the converter 653 to a voltage needed for operating the display portion 602. In addition, when display on the display portion 602 is not performed, the switch 654 is turned off and the switch 655 is turned on so that the battery 651 may be charged.

Although the solar cell 611 is described as an example of a power generation means, there is no particular limitation on the power generation means, and the battery 651 may be charged with any of the other means such as a piezoelectric element or a thermoelectric conversion element (Peltier element). For example, the battery 651 may be charged with a non-contact power transmission module capable of performing charging by transmitting and receiving electric power wirelessly (without contact), or any of the other charge means used in combination.

It is needless to say that one embodiment of the present invention is not limited to the electronic device illustrated in FIGS. 8A to 8C as long as the power storage device of one embodiment of the present invention, which is described in the above embodiment, is included.

### Embodiment 8

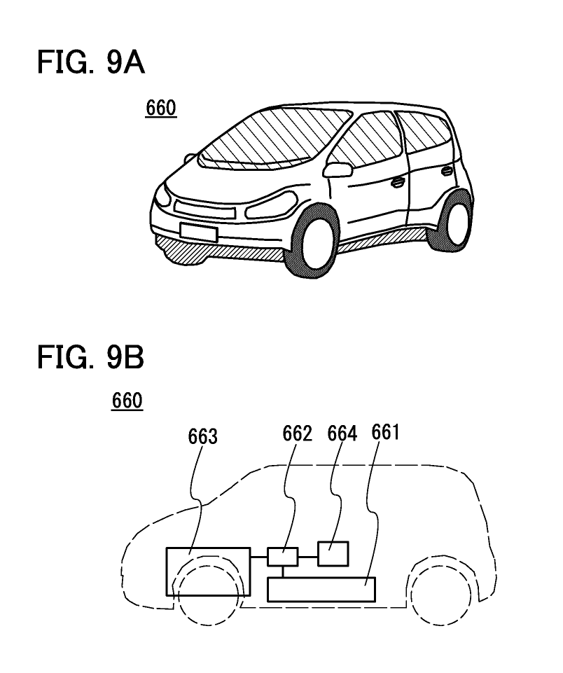

Further, an example of the moving object which is an example of the electronic devices will be described with reference to FIGS. 9A and 9B.

The power storage device of one embodiment of the present invention, which is described in the above embodiment, can be used as a control battery. The control battery can be externally charged by electric power supply using a plug-in technique or contactless power feeding. Note that in the case where the moving object is an electric railway vehicle, the electric railway vehicle can be charged by electric power supply from an overhead cable or a conductor rail.

FIGS. 9A and 9B illustrate an example of an electric vehicle. An electric vehicle 660 is equipped with a battery 661. The output of the electric power of the battery 661 is adjusted by a control circuit 662 and the electric power is supplied to a driving device 663. The control circuit 662 is controlled by a processing unit 664 including a ROM, a RAM, a CPU, or the like which is not illustrated.

The driving device 663 includes a DC motor or an AC motor either alone or in combination with an internal-combustion engine. The processing unit 664 outputs a control signal to the control circuit 662 based on input data such as data on operation (e.g., acceleration, deceleration, or stop) of a driver or data during driving (e.g., data on an upgrade or a downgrade, or data on a load on a driving wheel) of the electric vehicle 660. The control circuit 662 adjusts the electric energy supplied from the battery 661 in accordance with the control signal of the processing unit 664 to control the output of the driving device 663. In the case where the AC motor is mounted, although not illustrated, an inverter which converts direct current into alternate current is also incorporated.

The battery 661 can be charged by external electric power supply using a plug-in technique. For example, the battery 661 is charged through a power plug from a commercial power supply. The battery 661 can be charged by converting the supplied power into DC constant voltage having a predetermined voltage level through a converter such as an AC-DC converter. The use of the power storage device of one embodiment of the present invention as the battery 661 can be conducive to an increase in battery capacity, leading to an improvement in convenience. When the battery 661 itself can be more compact and more lightweight as a result of improved characteristics of the battery 661, the vehicle can be lightweight, leading to an increase in fuel efficiency.

Note that it is needless to say that one embodiment of the present invention is not limited to the electronic device described above as long as the power storage device of one embodiment of the present invention is included.

This embodiment can be implemented in combination with any of the other embodiments and the example as appropriate.

### Example 1

In this example, the characteristics of coating films each used for the electrode material for a power storage device of one embodiment of the present invention were evaluated. The evaluation method is as follows.

### (Measurement of Electric Resistivity of Coating Film)

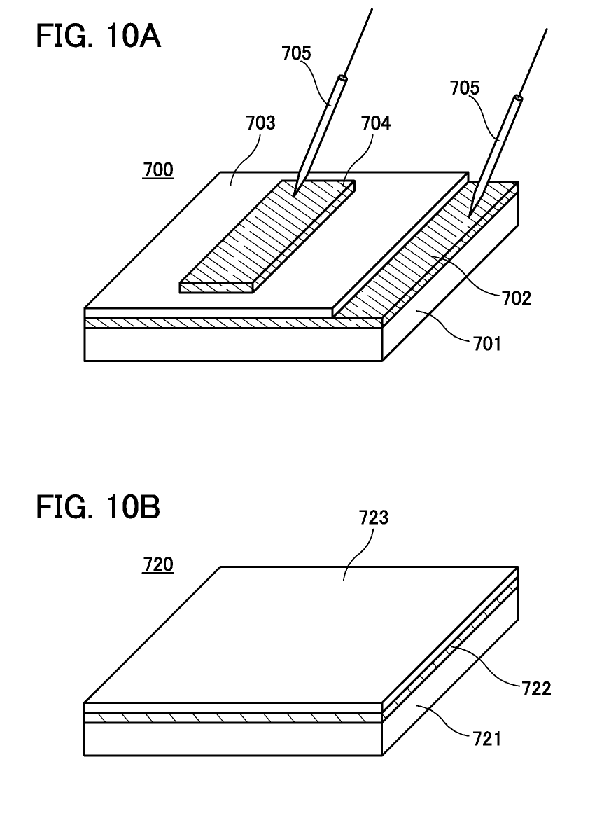

First, the electric resistivities of the coating films each used for the electrode material for a power storage device of one embodiment of the present invention were measured. The measurement was performed on the following three kinds of coating film materials of the electrode material for a power storage device: niobium oxide, silicon oxide, and aluminum oxide. The measurement of the electric resistivities will be described with reference to FIG. 10A.

The electric resistivity of the coating film was obtained by practically measuring the electric resistance of the coating film. First, a measurement sample 700 for measurement of the electric resistance of a coating film was formed as illustrated in FIG. 10A. The measurement sample 700 includes a first electrode 702 made of a conductor over a substrate 701, a coating film 703 provided over part of the first electrode 702 so that a surface of the first electrode is partly exposed, a second electrode 704 provided over the coating film 703. A glass substrate was used as the substrate 701, and the first electrode 702 was formed of a stack of a titanium film, an aluminum film, and a titanium film over the substrate 701 by a sputtering method. The coating film 703, which is an object to be measured, was formed by an electron beam evaporation method. As for a sample formed using niobium oxide for the coating film 703, a Nb₂O₅ powder was molded into a pellet state and the obtained pellet was deposited on the first electrode 702 by an electron beam evaporation method. As for a sample formed using silicon oxide for the coating film 703, a SiO₂ powder was molded into a pellet state and the obtained pellet was deposited on the first electrode 702 by an electron beam evaporation method. As for a sample formed using aluminum oxide for the coating film 703, an Al₂O₃ powder was molded into a pellet state and the obtained pellet was deposited on the first electrode 702 by an electron beam evaporation method. Each coating film 703 was formed to a thickness of 100 nm. After that, aluminum was deposited on the coating film 703 with a metal mask in which an opening was formed to have the shape of the electrode interposed therebetween by a sputtering method, and the second electrode 704 with a known area (7.9×10⁻⁷ m) was formed.

The electric resistance of each of the coating films 703 was measured by a two-probe method in such a manner that the first electrode 702 and the second electrode 704 were brought into contact with a measurement probe 705. For the measurement, a semiconductor parameter analyzer 4155C manufactured by Agilent Technologies, Inc. was used. The measurement was performed in an air-conditioned environment at 25° C. Table 1 shows the electric resistivities (unit: Ωm) of the coating films each of which was obtained by multiplying the obtained resistance value by (the area of the second electrode 704 (7.9×10⁻⁷ m)/the thickness of the coating film 703 (100 nm)).

TABLE 1

| Film | Electric Resistivity |
|---|---|
| Niobium oxide | 3.54 × 10⁷ |
| Silicon oxide | 1.89 × 10⁹ |
| Aluminum oxide | 3.47 × 10⁹ |

Unit: πm

The measurement results show that the electric resistivity of aluminum oxide is twice that of silicon oxide. They also show that the electric resistivity of niobium oxide is two orders of magnitude less than those of silicon oxide and aluminum oxide.

### (Correlation Between Thickness of Coating Film and Thickness of Surface Film)

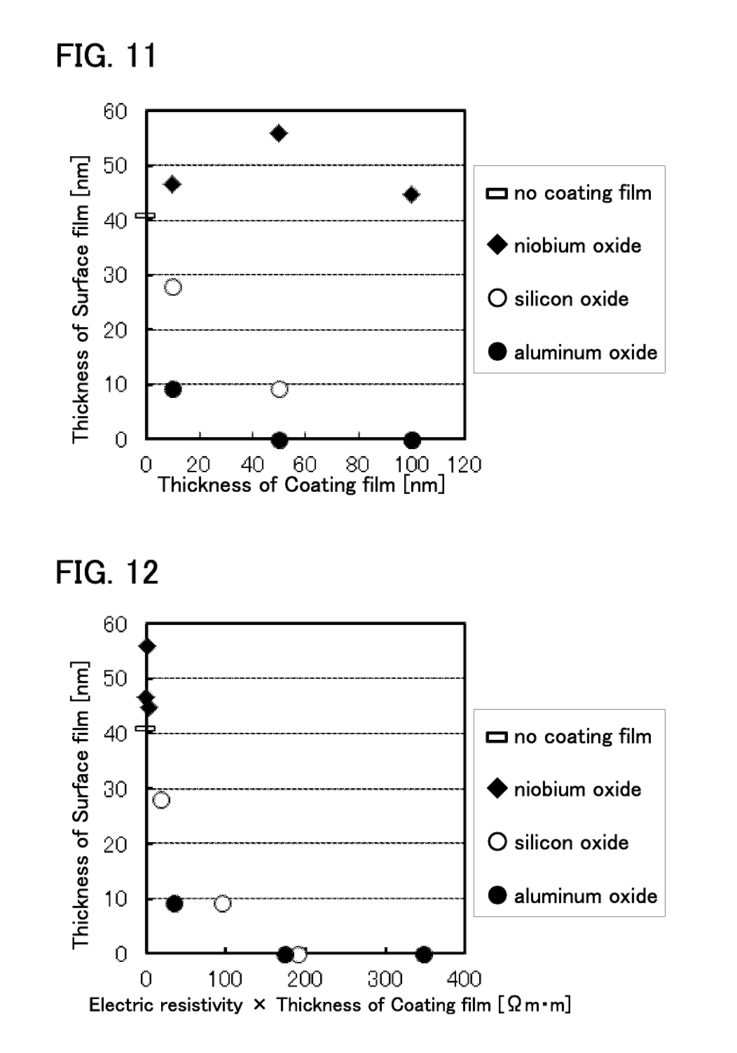

Next, measurement for examining the correlation between the thickness of a coating film formed on a surface of an active material and the thickness of a surface film formed due to charge and discharge was performed. The measurement will be described with reference to FIGS. 10A and 10B and FIG. 11.

The measurement was performed on a plurality of model electrodes formed as measurement samples 720. Specifically, a titanium sheet TR270c manufactured by JX Nippon Mining & Metals Corporation was used as the substrate 721, and an amorphous silicon film 722 regarded as an active material was formed over the substrate 721 with a reduced-pressure CVD apparatus. The amorphous silicon film 722 was formed under the following conditions: the flow rate of SiH₄ was 300 sccm; the flow rate of N₂ was 300 sccm; the pressure in the deposition chamber was 100 Pa; and the temperature was 550° C. A plurality of the stacks were prepared and a coating film 723 formed of niobium oxide, a coating film 723 formed of silicon oxide, and a coating film 723 formed of aluminum oxide were formed on the respective amorphous silicon films 722.

As for the coating film 723 formed of niobium oxide, a Nb₂O₅ powder was molded into a pellet state and the obtained pellet was deposited on the amorphous silicon film 722 by electron beam heating. In a similar manner, as for the coating film 723 formed of silicon oxide, a SiO₂ powder was molded into a pellet state and the obtained pellet was deposited on the amorphous silicon film 722 by electron beam heating, and as for the coating film 723 formed of aluminum oxide, an Al₂O₃ powder was molded into a pellet state and the obtained pellet was deposited on the amorphous silicon film 722 by the electron beam evaporation.

In the above manner, the measurement samples 720 having the coating films 723 formed of niobium oxide, the coating films 723 formed of silicon oxide, and the coating films 723 formed of aluminum oxide were prepared. The thicknesses of the coating films 723 formed of each of the materials are 10 nm, 50 nm, and 100 nm. In addition, a comparative measurement sample which is not provided with the coating film 723 and in which the amorphous silicon film 722 is exposed was prepared.

The above measurement samples were provided as electrodes in coin cells (half cells) for evaluation, constant current (CC) discharge was performed so that lithium whose electric charge amount corresponds to one fourth of the theoretical capacity of silicon was inserted at 25° C. In each of the coin cells for evaluation, a lithium metal was used as a negative electrode; polypropylene (PP) was used as a separator; and a mixed solution of ethylene carbonate (EC) and diethyl carbonate (DEC) (EC: DEC=1:1) which contains lithium hexafluorophosphate (LiPF₆) at a concentration of 1 mol/L was used as an electrolytic solution.

After the insertion of lithium into the amorphous silicon film 722 by CC discharge, each of the coin cells for evaluation was disassembled and each of the measurement samples was washed with dimethyl carbonate (DMC).

A surface of each of the measurement samples 720 formed in the above manner was irradiated with an electron beam by Auger electron spectroscopy (AES) to determine and measure the existence and the thickness of a surface film.

For Auger electron spectroscopy, PHI-680 manufactured by ULVAC-PHI, Incorporated was used as a measurement apparatus, and a profile in the depth direction from an outermost surface of the measurement sample 720 was obtained to determine and measure the existence and the thickness of a surface film. FIG. 11 shows the relation between the thicknesses of surface films, which were obtained by Auger electron spectroscopy, and the thicknesses of the coating films formed of niobium oxide, the coating films formed of silicon oxide, and the coating films formed of aluminum oxide. FIG. 11 also shows the result of the comparative measurement sample without a coating film.

In FIG. 11, the horizontal axis represents the thickness (unit: nm) of the coating film 723, and the vertical axis represents the thickness (unit: nm) of a surface film formed on the coating film 723 (on the amorphous silicon film 722 in the comparative measurement sample).

According to the result, in the case of the coating films 723 formed of niobium oxide, surface films were formed on surfaces of all the coating films having thicknesses of 10 nm, 50 nm, and 100 nm. The surface films were formed in CC discharge of the coin cells for evaluation. In the case of the coating films 723 formed of silicon oxide, surface films were formed on surfaces of the coating films having thicknesses of 10 nm and 50 nm, whereas a surface film was not detected on a surface of the coating film having a thickness of 100 nm. In the case of the coating films 723 formed of aluminum oxide, a surface film was formed on a surface of the coating film having a thickness of 10 nm, whereas a surface film was not detected on a surface of each of the coating films having thicknesses of 50 nm and 100 nm.

Thus, the result of Auger analysis indicates that the coating films 723 formed of aluminum oxide had a more excellent effect of suppressing decomposition of the electrolytic solution than the coating films 723 formed of silicon oxide. The coating films 723 formed of niobium oxide and having the above thicknesses did not have an effect of suppressing decomposition of the electrolytic solution.

(Evaluation of Coating films)

FIG. 12 shows a graph with a horizontal axis representing the product of the electric resistivity (Ωm) and the thickness (m), where the obtained correlation between the thicknesses of the coating films and the thicknesses of the surface films in FIG. 11 is plotted taking the measurement result of the electric resistivities of the coating films into consideration.

In FIG. 12, the horizontal axis represents the product of the electric resistivity and the thickness (unit: Ωm·nm) of the coating film 723, and the vertical axis represents the thickness (unit: nm) of the surface film formed on the coating film 723 (on the amorphous silicon film 722 in the comparative measurement sample).

As shown in FIG. 12, the coating films 723 have similar curves regardless of the material thereof. Specifically, in the case where the product of the electric resistivity and the thickness of the coating film 723 is small, a surface film is formed thick, and as the product of the electric resistivity and the thickness of the coating film 723 is larger, the thickness of a surface film is smaller. That is to say, an increase in the product of the electric resistivity and the thickness of the coating film 723 presumably leads to suppression of the decomposition reaction of the electrolytic solution and inhabitation of formation of a surface film.

Therefore, by setting the product of the electric resistivity and the thickness of the coating film 723 to a predetermined value, the existence and/or the thickness of a surface film formed on the electrode material can be controlled regardless of the material of the coating film 723.

In FIG. 12, for example, when the product of the electric resistivity and the thickness of the coating film 723 formed of silicon oxide was 18.93 Ωm·m, the thickness of the surface film formed on the coating film was 28.0 nm. This result suggests that the thickness of a surface film formed due to the surface reaction between the electrolytic solution and the active material can be smaller when the product of the electric resistivity and the thickness of the coating film 723 is set to 20 Ωm·m or larger. Further, the result also suggests that formation of a surface film can be suppressed when the product of the electric resistivity and the thickness of the coating film 723 is set to 200 Ωm·m or larger.

Thus, the use of an electrode material for a power storage device in which such a coating film as described above is formed on part of the surface of an active material particle can reduce irreversible capacity, which can reduce the initial capacity of a power storage device and can reduce or suppress electrochemical decomposition of an electrolytic solution. Further, the cycle performance and calendar life (retention property) of the power storage device can be improved. Furthermore, the decomposition reaction of an electrolytic solution, which is accelerated at high temperature, is reduced or suppressed and a decrease in capacity in charging and discharging at high temperature is prevented, so that the operating temperature range of the power storage device can be extended.

This application is based on Japanese Patent Application serial no. 2012-208126 filed with the Japan Patent Office on Sep. 21, 2012, the entire contents of which are hereby incorporated by reference.

What is claimed is:

1. An electrode material for a power storage device, comprising:
an active material particle; and
a coating film covering part of the active material particle,
wherein the coating film has carrier ion conductivity, and
wherein a product of an electric resistivity and a thickness of the coating film at 25° C. is greater than or equal to 20 Ωm·m.

2. The electrode material for a power storage device according to claim 1, wherein the coating film is in contact with the active material particle.

3. The electrode material for a power storage device according to claim 1, wherein a Young's modulus of the coating film is less than or equal to 70 GPa.

4. The electrode material for a power storage device according to claim 1, wherein the coating film comprises one of silicon oxide, aluminum oxide, a lithium silicon complex oxide, and a lithium aluminum complex oxide.

5. The electrode material for a power storage device according to claim 1, wherein the active material particle comprises one of graphite, carbon, silicon, and a silicon alloy.

6. An electrode material for a power storage device, comprising:
an active material particle; and
a coating film covering part of the active material particle,
wherein the coating film has carrier ion conductivity, and
wherein a product of an electric resistivity and a thickness of the coating film at 25° C. is greater than or equal to 200 Ωm·m.

7. The electrode material for a power storage device according to claim 6, wherein the coating film is in contact with the active material particle.

8. The electrode material for a power storage device according to claim 6, wherein a Young's modulus of the coating film is less than or equal to 70 GPa.

9. The electrode material for a power storage device according to claim 6, wherein the coating film comprises one of silicon oxide, aluminum oxide, a lithium silicon complex oxide, and a lithium aluminum complex oxide.

10. The electrode material for a power storage device according to claim 6, wherein the active material particle comprises one of graphite, carbon, silicon, and a silicon alloy.

11. An electrode comprising:
a current collector; and
an active material layer including at least a binder, active material particles, and coating films, over the current collector,
wherein part of the active material particle is covered with the coating film,
wherein the coating film has carrier ion conductivity, and
wherein a product of an electric resistivity and a thickness of the coating film at 25° C. is greater than or equal to 20 Ωm·m.

12. A power storage device comprising the electrode according to claim 11.

13. An electronic device comprising the power storage device according to claim 12.

14. The electrode according to claim 11, wherein the coating film is in contact with the active material particle.

15. The electrode according to claim 11, wherein a Young's modulus of the coating film is less than or equal to 70 GPa.

16. An electrode comprising:
a current collector; and
an active material layer including at least a binder, active material particles, and coating films, over the current collector,
wherein part of the active material particle is covered with the coating film,
wherein the coating film has carrier ion conductivity, and
wherein a product of an electric resistivity and a thickness of the coating film at 25° C. is greater than or equal to 200 Ωm·m.

17. A power storage device comprising the electrode according to claim 16.

18. An electronic device comprising the power storage device according to claim 17.

19. The electrode according to claim 16, wherein the coating film is in contact with the active material particle.

20. The electrode according to claim 16, wherein a Young's modulus of the coating film is less than or equal to 70 GPa.
